(19) United States
(12) Patent Application Publication
(10) Pub. No.: US 2008/0240588 A1
(43) Pub. Date: Oct. 2, 2008

(54) Image processing method and image processing apparatus

(76) Inventors: Mikhail Tsoupko-Sitnikov, Campbell, CA (US); Igor Borovikov, Foster City, CA (US)

Correspondence Address: Ralph A. Dowell of DOWELL & DOWELL P.C., 2111 Eisenhower Ave, Suite 406, Alexandria, VA, 22314, US

(21) Appl. No.: 11/730,018

(22) Filed: Mar. 29, 2007

(51) Int. Cl. G06K 9/36

(52) U.S. Cl. 382/236

(57) ABSTRACT

An image processing technology is provided that lends itself to improving precision of image matching. Keyframe to keyframe matching point information is generated by combining image frame to image frame corresponding point information obtained by computing matching in a group of image frames which includes a first keyframe and a second keyframe as a source and a destination, respectively. Image matching between the first and second keyframes is directly computed by using, of the entire keyframe to keyframe corresponding point information, the corresponding point information evaluated to be highly reliable as a constraint condition.

### BACKGROUND OF THE INVENTION

1. Field of the Invention

The present invention relates to an image matching technology for computing matching between keyframes.

2. Description of the Related Art

Presently, as solid infrastructure for multimedia environment has become established both in terms of hardware and software, contents including moving images are fairly generally available. This is largely due to the development in compression technology like Motion Picture Expert Group (MPEG). The technology focuses on spatial frequency and performs compression between keyframes so as to encode moving images and reduce the amount of data of moving images. The technology generally available to generate moving images, like MPEG, uses block matching as a method of computing matching between keyframes with the result that block noise is sometimes generated and the quality of display is impaired accordingly.

Several new matching technologies are proposed in order to overcome the disadvantage of the block matching technology. Of all these technologies, the pixel-based matching technology has produced dramatically improved matching levels (see, for example, patent document No. 1).

We also proposed in patent document No. 2 a pixel-based matching technology directed to improving the efficiency of recording consecutive image data. According to this proposal, adjacent image frames, of the entirety of consecutive image frames, are subject to matching computation so as to generate corresponding point information for each pair of the adjacent image frames. The plurality of sets of corresponding point information are combined into a single set of corresponding point information, with the result that corresponding point information on image frames that are not adjacent to each other is generated. Hereinafter, the process may be referred to as concatenation.
[patent document No. 1]
JP Patent 2927350
[patent document No. 2]
JP 2002-204458

While the above-mentioned proposal is capable of achieving high-precision pixel-based matching, further improvement in precision may be called for in practical applications, depending on the contents of images.

### SUMMARY OF THE INVENTION

In this background, a general purpose of the present invention is to provide an image processing technology that lends itself to improvement of precision of image matching.

An embodiment of the present invention relates to an image processing method. The method comprises a concatenation and a refinement step.

In the concatenation step, information on corresponding points in keyframes (hereinafter, referred to as keyframe to keyframe corresponding point information) is generated by combining corresponding point information indicating correspondence between image frames obtained by subjecting an image frame group which includes a first keyframe and a second keyframe as a source and a destination, respectively, to a matching process. That is, concatenation is performed on the first and second keyframes. In the refinement step, image matching is directly computed between the first and second keyframes using the keyframe to keyframe corresponding point information evaluated to be highly reliable as a constraint condition.

Basically, concatenation is capable of achieving high-precision matching but is reinforced by directly computing image matching between keyframes, wherein, of the entire corresponding point information originated from concatenation, the keyframe to keyframe corresponding point information, evaluated to be highly reliable is used as a constraint condition. Thus, adverse effects, from accumulation of errors occurring as a result of concatenation, on image quality is mitigated.

Another embodiment of the present invention relates to an image processing method. The method comprises a preparatory matching step and a primary matching step. In the preparatory matching step, image matching between a first keyframe and a second keyframe is computed so as to generate corresponding point information indicating matching between the first and second keyframes. Once the preparatory matching step is completed, the primary matching step re-computes image matching between the first keyframe and the second keyframe under a constraint condition defined based on the corresponding point information indicating correspondence between the first and second keyframes, thereby updating the keyframe to keyframe corresponding point information.

In the primary matching step, image matching between the first keyframe and the second keyframe may be computed with the same level of resolution as the preparatory matching step under the constraint condition defined based on the corresponding point information indicating matching between the first and second keyframes.

The algorithm for executing the preparatory matching and the algorithm for executing the primary matching step may include a common image matching algorithm. The common image matching algorithm may be an algorithm for performing image matching by applying a multiresolutional critical point filter to each of the two image frames. In the preparatory matching step, concatenation may be performed. In the primary matching step, image matching between the keyframes may be directly computed.

Any arbitrary replacement or substitution of the above-described structural components and the steps, expressions replaced or substituted in part or whole between a method and an apparatus as well as addition thereof, and expressions changed to a computer program, recording medium or the like are all effective as and encompassed by the present embodiments.

### BRIEF DESCRIPTION OF THE DRAWINGS

FIG. 1a is an image obtained as a result of the application of an averaging filter to a human facial image.

FIG. 1b is an image obtained as a result of the application of an averaging filter to another human facial image.

FIG. 1c is an image of a human face at p^{(5,0)} obtained in a preferred embodiment in the base technology.

FIG. 1d is another image of a human face at p^{(5,0)} obtained in a preferred embodiment in the base technology.

FIG. 1e is an image of a human face at p^{(5,1)} obtained in a preferred embodiment in the base technology.

FIG. 1f is another image of a human face at p^{(5,1)} obtained in a preferred embodiment in the base technology.

FIG. 1g is an image of a human face at p^{(5,2)} obtained in a preferred embodiment in the base technology.

FIG. 1h is another image of a human face at p^{(5,2)} obtained in a preferred embodiment in the base technology.

FIG. 1i is an image of a human face at p^{(5,3)} obtained in a preferred embodiment in the base technology.

FIG. 1j is another image of a human face at p^{(5,3)} obtained in a preferred embodiment in the base technology.

FIG. 2R shows an original quadrilateral.

FIG. 2A shows an inherited quadrilateral.

FIG. 2B shows an inherited quadrilateral.

FIG. 2C shows an inherited quadrilateral.

FIG. 2D shows an inherited quadrilateral.

FIG. 2E shows an inherited quadrilateral.

FIG. 3 is a diagram showing the relationship between a source image and a destination image and that between the m-th level and the (m−1)th level, using a quadrilateral.

FIG. 4 shows the relationship between a parameters η (represented by x-axis) and energy C_{f} (represented by y-axis).

FIG. 5a is a diagram illustrating determination of whether or not the mapping for a certain point satisfies the bijectivity condition through the outer product computation.

FIG. 5b is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source hierarchical images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 12.

FIG. 16 is a graph showing the behavior of energy C_{f}^{(m,s)} corresponding to f^{(m,s)} (λ=iΔλ) which has been obtained for a certain f^{(m,s)} while varying λ.

FIG. 17 is a diagram showing the behavior of energy C_{f}⁽ⁿ⁾ corresponding to f⁽ⁿ⁾ (η=iΔη) (i=0,1, . . . ) which has been obtained while varying η.

FIG. 18 shows the overall structure of an example of an image processing system 10.

FIG. 19 shows the structure of an image processing system according to an embodiment.

FIG. 20 shows how corresponding points in frames are sequentially combined.

FIG. 21 is a flowchart showing a matching method for generating correspondence between keyframes by sequentially combining correspondence between adjacent frames.

FIG. 22 shows image data in which keyframe data and keyframe to keyframe corresponding point data are associated with each other.

FIG. 23 is a flowchart showing a method of decoding image data.

FIG. 24 shows an example of locus function data.

FIG. 25 shows a locus function file that stores corresponding point data for keyframes and locus function data, in association with each other.

FIG. 26 shows an example of the image processing system according to the embodiment.

FIG. 27 shows how a hint point is detected according to the embodiment.

FIG. 28 is a flowchart showing how keyframe to keyframe matching is computed under a constraint condition according to this embodiment.

### DETAILED DESCRIPTION OF THE INVENTION

The invention will now be described by reference to the preferred embodiments. This does not intend to limit the scope of the present invention, but to exemplify the invention.

At first, the multiresolutional critical point filter technology and the image matching processing using the technology, both of which will be utilized in the preferred embodiments, will be described in detail as “Base Technology”. These techniques are patented under Japanese Patent No. 2927350 and owned by the same assignee of the present invention, and they realize an optimal achievement when combined with the present invention. However, it is to be noted that the image matching techniques which can be adopted in the present embodiments are not limited to this.

In computing image matching between key frames according to the present invention, a constraint condition is set up on the basis of correspondence already obtained between key frames. This can achieve more favorable image quality than when image matching is simply computed between key frames. The base technology may be used for matching between key frames according to the present invention. Alternatively, the base technology may be used to obtain key frame to key frame correspondence required to set up a constraint condition.

Namely, the following sections of [1],[2] and [3] belong to the base technology, where [1] describes elemental techniques [2] describes a processing procedure, and [3] describes an improvement of the technique described in [1] and [2].

### [1] Detailed Description of Elemental Techniques

### [1.1] Introduction

Using a set of new multiresolutional filters called critical point filters, image matching is accurately computed. There is no need for any prior knowledge concerning objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, smooth generation of motion images from a small number of frames. When applied to the morphing, given images can be automatically transformed. When applied to the volume rendering, intermediate images between cross sections can be accurately reconstructed, even when the distance between them is rather long and the cross sections vary widely in shape.

### [1.2] The Hierarchy of the Critical Point Filters

The multiresolutional filters according to the base technology can preserve the intensity and locations of each critical point included in the images while reducing the resolution. Now, let the width of the image be N and the height of the image be M. For simplicity, assume that N=M=2n where n is a positive integer. An interval [0, N]⊂R is denoted by I. A pixel of the image at position (i, j) is denoted by p^{(i,j)} where i, jεI.

Here, a multiresolutional hierarchy is introduced. Hierarchized image groups are produced by a multiresolutional filter. The multiresolutional filter carries out a two dimensional search on an original image and acquires critical points therefrom. The multiresolutinal filter then extracts the critical points from the original image to construct another image having a lower resolution. Here, the size of each of the respective images of the m-th level is denoted as 2^{m}×2^{m} (0 m n). A critical point filter constructs the following four new hierarchical images recursively, in the direction descending from n.

p_{(i,j)}^{(m,0)}=min(min(p_{(2i,2j)}^{(m+1,0)},p_{(2i,2j+1)}^{(m+1,0)},min(p_{(2i+1,2j)}^{(m+1,0)},p_{(2i+1,2j+1)}^{(m+1,0)} ))

p_{(i,j)}^{(m,0)}=max(min(p_{(2i,2j)}^{(m+1,1)},p_{(2i,2j+1)}^{(m+1,1)}),min(p_{(2i+1,2j)}^{(M+1,1)},p_{2i+1,2j+1)}^{(m+1,1)}))

p_{(i,j)}^{(m,2)}=min(max(p_{2i,2j)}^{m+1,2)},p_{(2i,2j+1)}^{(m+1,2)}),max(p_{(2i+1,2j)}^{(m+1,2)},p_{(2i+1,2j+1)}^{(m+1,2)}))

p_{(i,j)}^{(m,3)}=max(max(p_{(2i,2j)}^{(m+1,3)},p_{(2i,2j+1)}^{(m+1,3)}),max(p_{2i+1,2j)}^{(m+1,3)},p_{(2i+1,2j+1)}^{(m+1,3)})) (1)

where let

p_{(i,j)}^{(n,0)}=p_{(i,j)}^{(n,1}=p_{(i,j)}^{(n,2)}=p_{(i,j)}^{(n,3)}=p_{(i,j)} (2)

The above four images are referred to as subimages hereinafter. When min_{x≦t≦x+1} and max_{x≦t≦x+1} are abbreviated to and α and β, respectively, the subimages can be expressed as follows.

p^{(m,0)}=α(x)α(y)p^{(m+1,0)}

p^{(m,1)}=α(x)β(y)p^{(m+1,1)}

p^{(m,2)}=β(x)α(y)p^{(m+1,2)}

p^{(m,2)}=β(x)β(y)p^{(m+1,3)}

Namely, they can be considered analogous to the tensor products of α and β. The subimages correspond to the respective critical points. As is apparent from the above equations, the critical point filter acquires a critical point of the original image for every block consisting of 2×2 pixels. In this acquireion, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are acquired as a local maximum point, a local minimum point, and a saddle point, respectively.

By using the critical point filter, an image (1 pixel here) of a critical point acquired inside each of the respective blocks serves to represent its block image (4 pixels here). Thus, resolution of the image is reduced. From a singularity theoretical point of view, α(x)α(y) preserves the local minimum point (minima point), β(x)β(y) preserves the local maximum point(maxima point), α(x)β(y) and β(x)α(y) preserve the saddle point.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of the resolution levels. First, the minima points are matched using p^{(m,0)}. Next, the saddle points are matched using p^{(m,1)} based on the previous matching result for the minima points. Other saddle points are matched using p^{(m,2)} Finally, the maxima points are matched using p^{(m,3)}

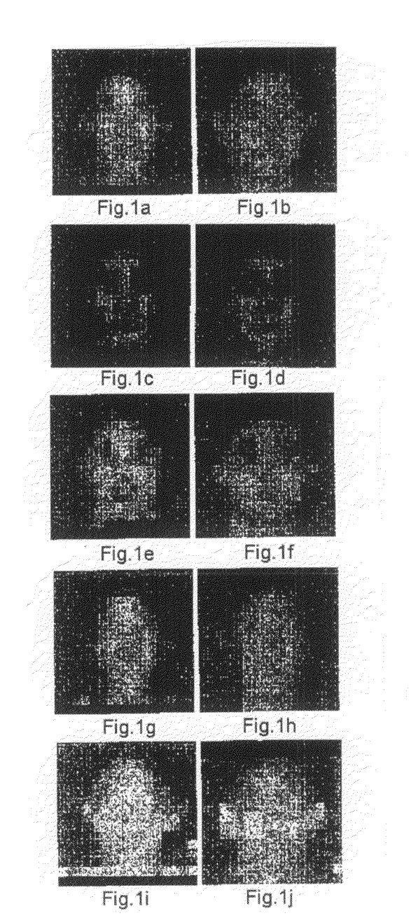

FIGS. 1(c) and 1(d) show the subimages p^{(5,0)} of the images in FIGS. 1(a) and 1(b), respectively. Similarly, FIGS. 1(e) and 1(f) show the subimages p^{(5,1)}. FIGS. 1(g) and 1(h) show the subimages p^{(5,2)}. FIGS. 1(i) and 1(j) show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1)} since the mouths have low intensity in the horizontal direction. Vertical lines on the both sides of the necks become clear by p^{(5,2)}. The ears and bright parts of cheeks become clear by p^{(5,3)} since these are the maxima points of pixel intensity.

As described above, the characteristics of an image can be extracted by the critical point filter. Thus, by comparing, for example, the characteristics of an image shot by a camera and with the characteristics of several objects recorded in advance, an object shot by the camera can be identified.

### [1.3] Computation of Mapping Between Images

The pixel of the source image at the location (i,j) is denoted by p_{(i,j)}⁽ⁿ⁾ and that of the destination image at (k,1) is denoted by q_{(k,l)}⁽ⁿ⁾ where i, j, k, 1εI. The energy of the mapping between the images (described later) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)}and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0,1,2, . . . ) is referred to as a submapping. The order of i will be rearranged as shown in the following (3) in computing f^{(m,i)} for the reasons to be described later.

f^{(m,i)}:p^{(m,σ(i))}→q^{(m,σ(i))} (3)

where σ(i)ε{0, 1, 2, 3}.

### [1.3.1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be to be noted that the mappings to be constructed here are the digital version of the bijection. In the base technology, a pixel is specified by a grid point.

The mapping of the source subimage (a subimage of a source image) to the destination subimage (a subimage of a destination image) is represented by f^{(m,s)}: I/2^{n-m} X I/2^{n-m}→I/2^{n-m} X I/2^{n-m} (s=0, 1, . . . ), where f_{(i,j)}^{(m,s)}=(k,l) means that p_{(k,l)}^{(m,s)} of the source image is mapped to q_{(k,l)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bijection will be defined in the following manner, where i,i′,j,j′,k and l are all integers. First, each square region (4)

p_{(i,j)}^{(m,s)}p_{i+1,j)}^{(m,s)}p_{i+1,j+1)}^{(m,s)}p_{(i,j+1)}^{(m,s)} (4)

on the source image plane denoted by R is considered, where i=0, . . . , 2^{m}−1, and j=0, . . . , 2^{m}−1. The edges of R are directed as follows.

p̅_̅{̅(̅i̅,̅j̅)̅}̅^̅{̅(̅m̅,̅s̅)̅}̅p̅_̅{̅i̅+̅1̅,̅j̅)̅}̅^̅{̅(̅m̅,̅s̅)̅}̅ p̅_̅{̅(̅i̅,̅j̅)̅}̅^̅{̅(̅m̅,̅s̅)̅}̅p̅_̅{̅i̅+̅1̅,̅j̅)̅}̅^̅{̅(̅m̅,̅s̅)̅}̅ p̅_̅{̅(̅i̅,̅j̅)̅}̅^̅{̅(̅m̅,̅s̅)̅}̅p̅_̅{̅i̅+̅1̅,̅j̅)̅}̅^̅{̅(̅m̅,̅s̅)̅}̅, p̅_̅{̅(̅i̅+̅1̅,̅j̅)̅}̅^̅{̅(̅m̅,̅s̅)̅}̅p̅_̅{̅(̅i̅+̅1̅,̅j̅+̅1̅)̅}̅^̅{̅m̅,̅s̅)̅}̅ p̅_̅{̅(̅i̅+̅1̅,̅j̅)̅}̅^̅{̅(̅m̅,̅s̅)̅}̅p̅_̅{̅(̅i̅+̅1̅,̅j̅+̅1̅)̅}̅^̅{̅m̅,̅s̅)̅}̅ p̅_̅{̅(̅i̅+̅1̅,̅j̅)̅}̅^̅{̅(̅m̅,̅s̅)̅}̅p̅_̅{̅(̅i̅+̅1̅,̅j̅+̅1̅)̅}̅^̅{̅m̅,̅s̅)̅}̅, p̅_̅{̅(̅i̅+̅1̅,̅j̅+̅1̅)̅}̅^̅{̅(̅m̅,̅s̅)̅}̅p̅_̅{̅(̅i̅,̅j̅+̅1̅)̅}̅^̅{̅(̅m̅,̅s̅)̅}̅ p̅_̅{̅(̅i̅+̅1̅,̅j̅+̅1̅)̅}̅^̅{̅(̅m̅,̅s̅)̅}̅p̅_̅{̅(̅i̅,̅j̅+̅1̅)̅}̅^̅{̅(̅m̅,̅s̅)̅}̅ p̅_̅{̅(̅i̅+̅1̅,̅j̅+̅1̅)̅}̅^̅{̅(̅m̅,̅s̅)̅}̅p̅_̅{̅(̅i̅,̅j̅+̅1̅)̅}̅^̅{̅(̅m̅,̅s̅)̅}̅ p̅_̅{̅(̅i̅+̅1̅,̅j̅+̅1̅)̅}̅^̅{̅(̅m̅,̅s̅)̅}̅p̅_̅{̅(̅i̅,̅j̅+̅1̅)̅}̅^̅{̅(̅m̅,̅s̅)̅}̅ and p̅_̅{̅(̅i̅,̅j̅+̅1̅)̅}̅^̅{̅(̅m̅,̅s̅)̅}̅p̅_̅{̅(̅i̅,̅j̅)̅}̅^̅{̅(̅m̅,̅s̅)̅}̅ p̅_̅{̅(̅i̅,̅j̅+̅1̅)̅}̅^̅{̅(̅m̅,̅s̅)̅}̅p̅_̅{̅(̅i̅,̅j̅)̅}̅^̅{̅(̅m̅,̅s̅)̅}̅ p̅_̅{̅(̅i̅,̅j̅+̅1̅)̅}̅^̅{̅(̅m̅,̅s̅)̅}̅p̅_̅{̅(̅i̅,̅j̅)̅}̅^̅{̅(̅m̅,̅s̅)̅}̅ p̅_̅{̅(̅i̅,̅j̅+̅1̅)̅}̅^̅{̅(̅m̅,̅s̅)̅}̅p̅_̅{̅(̅i̅,̅j̅)̅}̅^̅{̅(̅m̅,̅s̅)̅}̅ (5)

This square will be mapped by f to a quadrilateral on the destination image plane. The quadrilateral (6)

q_{(i,j)}^{(m,s)}q_{(i+1,j)}^{(m,s)}q_{(i+1,j+1)}^{(m,s)}q_{i,j+1)}^{(m,s)} (6)

denoted by f^{(m,s)} (R) should satisfy the following bijectivity conditions(BC).

(So, f^{(m,s)}(R)=f^{(m,s)}(p_{(i,j)}^{(m,s)}p_{(i+1,j)}^{(m,s)}p_{(i+1,j+1)}^{(m,s)}p_{(i,j+1)}^{(m,s)})=q_{(i,j)}^{(m,s)}q_{(i+1,j)}^{(m,s)}q_{(i+1,j+1)}^{(m,s)}q_{(i,j+1)}^{(m,s)})

1. The edges of the quadrilateral f^{(m,s)} (R) should not intersect one another.

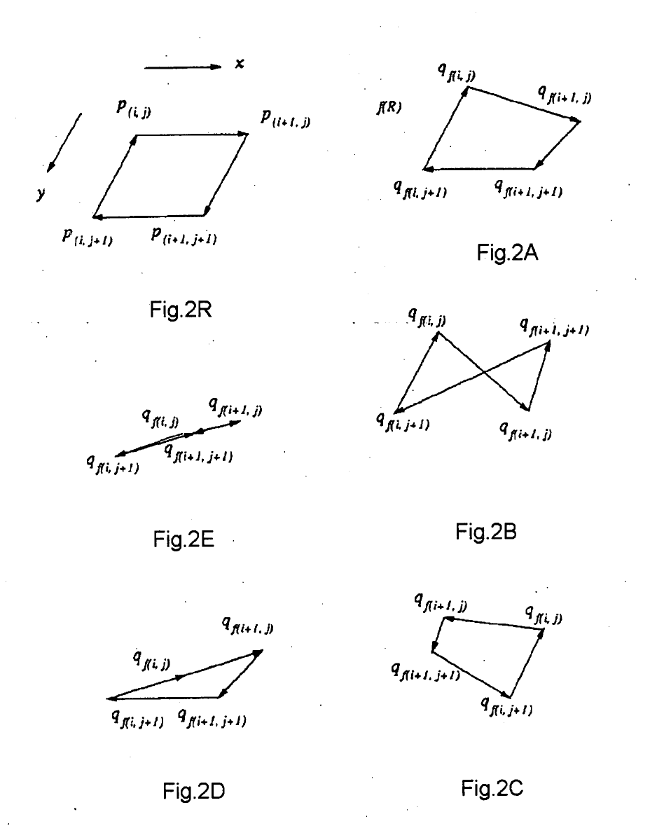

2. The orientation of the edges of f^{(m,s)} (R) should be the same as that of R (clockwise in the case of FIG. 2).

3. As a relaxed condition, retraction mapping is allowed.

The bijectivity conditions stated above shall be simply referred to as BC hereinafter.

Without a certain type of a relaxed condition, there would be no mappings which completely satisfy the BC other than a trivial identity mapping. Here, the length of a single edge of f^{(m,s)} (R) may be zero. Namely, f^{(m,s)} (R) may be a triangle. However, it is not allowed to be a point or a line segment having area zero. Specifically speaking, if FIG. 2(R) is the original quadrilateral, FIGS. 2(A) and 2(D) satisfy BC while FIGS. 2(B), 2(C) and 2(E) do not satisfy BC.

In actual implementation, the following condition may be further imposed to easily guarantee that the mapping is surjective. Namely, each pixel on the boundary of the source image is mapped to the pixel that occupies the same locations at the destination image. In other words, f(i,j)=(i,j) (on the four lines of i=0, i=2^{m}−1, j=0, j=2^{m}−1). This condition will be hereinafter referred to as an additional condition.

### [1.3.2] Energy of Mapping

### [1.3.2.1] Cost Related to the Pixel Intensity

The energy of the mapping f is defined. An objective here is to search a mapping whose energy becomes minimum. The energy is determined mainly by the difference in the intensity of between the pixel of the source image and its corresponding pixel of the destination image. Namely, the energy C_{(i,j)}^{(m,s)} of the mapping f^{(m,s)} at (i,j) is determined by the following equation (7).

C_{(i,j)}^{(m,s)}=″V(p_{(i,j)}^{(m,s)}−V(q_{f(i,j)}^{(m,s)})″² (7)

where V(p_{(i,j)}^{(m,s)}) and V(q_{f(i,j)}^{(m,s)}) are the intensity values of the pixels p_{(i,j)}^{(m,s)} and q_{f(i,j)}^{(m,s)}, respectively. The total energy C^{(m,s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} \qquad ( 8 )$$

### [1.3.2.2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0, 1, . . . , 2^{m}−1, j=0, 1, . . . , 2^{m}−1), regardless of the intensity of the pixels. The energy D_{(i,j)}^{(m,s)} of the mapping f^{(m,s)} at a point (i,j) is determined by the following equation (9).

D_{(i,j)}^{(m,s)}=ηE_{0(i,j)}^{(m,s)}+E_{1(i,j)}^{(m,s)} (9)

where the coefficient parameter η which is equal to or greater than 0 is a real number. And we have

$$\begin{matrix}{E}_{{0}_{( i , j )}}^{( m , s )} = {‖ ( i , j ) - {f}^{( m , s )} ( i , j ) ‖}^{2} & ( 10 ) \\ {E}_{{1}_{( i , j )}}^{( m , s )} = {\sum }_{{i}^{′} = i - 1}^{i} {\sum }_{{j}^{′} = j - 1}^{j} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 & ( 11 )\end{matrix}$$

where ∥(x,y)∥=\sqrt{x²+y²} (12)

and f(i′,j′) is defined to be zero for i′<0 and j′<0. E₀ is determined by the distance between (i,j) and f(i,j). E₀ prevents a pixel from being mapped to a pixel too far away from it. However, E₀ will be replaced later by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation (13).

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

### [1.3.2.3] Total Energy of the Mapping

The total energy of the mapping, that is, a combined evaluation equation which relates to the combination of a plurality of evaluations, is defined as λC_{(i,j)}^{(m,s)}+D_{f}^{(m,s)}, where λ≧0 is a real number. The goal is to detect a state in which the combined evaluation equation has an extreme value, namely, to find a mapping which gives the minimum energy expressed by the following (14).

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0 (i.e., f^{(m,s)} (i,j)=(i,j) for all i=0, 1, . . . , 2^{m}−1 and j=0, 1, . . . , 2^{m}−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would be randomly corresponded to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, the difference in the pixel intensity and smoothness is considered in the optical flow technique. However, the optical flow technique cannot be used for image transformation since the optical flow technique takes into account only the local movement of an object. Global correspondence can be detected by utilizing the critical point filter according to the base technology.

### [1.3.3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, while mappings at other level is being considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint conditions.

Now, when the following equation (15) holds,

$$( {i}^{′} , {j}^{′} ) = ( ⌊ \frac{i}{2} ⌋ , ⌊ \frac{j}{2} ⌋ ) \qquad ( 15 )$$

p_{(i,j)}^{(m-1,s)} and q_{(i,j)}^{(m-1,s)} are respectively called the parents of p_{(i,j)}^{(m,s)} and q_{(i,j)}^{(m,s)}, where └x┘ denotes the largest integer not exceeding x. Conversely, p_{(i,j)}^{(m,s)} and q_{(i,j)}^{(m,s)} are the child of p_{(i′,j′)}^{(m-1,s)} and the child of q_{(i′,j′)}^{(m-1,s)}, respectively. A function parent (i,j) is defined by the following (16).

$$parent ( i , j ) = ( ⌊ \frac{i}{2} ⌋ , ⌊ \frac{j}{2} ⌋ ) . \qquad ( 16 )$$

A mapping between p_{(i,j)}^{(m,s)} and q_{(k,l)}^{(m,s)} is determined by computing the energy and finding the minimum thereof. The value of f^{(m,s)} (i,j)=(k,l) is determined as follows using f(m−1,s) (m=1, 2, . . . , n). First of all, imposed is a condition that q_{(k,l)}^{(m,s)} should lie inside a quadrilateral defined by the following (17) and (18). Then, the applicable mappings are narrowed down by selecting ones that are thought to be reasonable or natural among them satisfying the BC.

Q_{g}_{^{(m,s)}}_{(i-1,j-1)}^{(m,s)}q_{g}_{^{(m,s)}}_{(i-1,j-1)}^{(m,s)}q_{g}_{^{(m,s)}}_{(i+1,j+1)}^{(m,s)}q_{g}_{^{(m,s)}}_{(i+1,j-1)}^{(m,s)} (17)

where

g^{(m,s)}(i,j)=f^{(m-1,s)}(parent(i,j)+f^{(m-1,s)}(parent(i,j)+(1,1)) (18)

The quadrilateral defined above is hereinafter referred to as the inherited quadrilateral of p_{(i,j)}^{(m,s)}. The pixel minimizing the energy is sought and obtained inside the inherited quadrilateral.

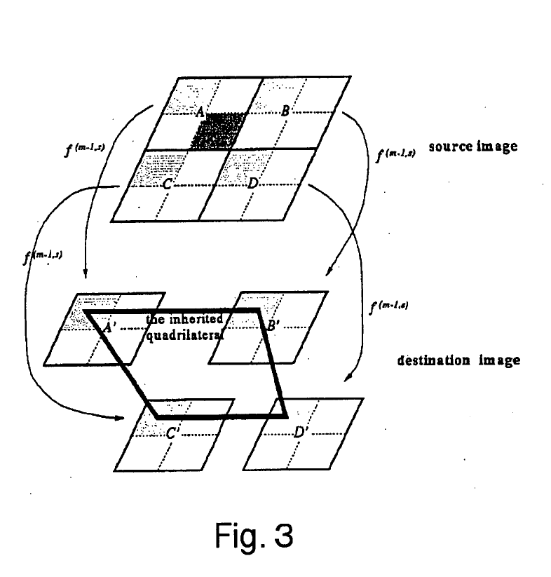

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above is now replaced by the following (19) and (20)

E_{0(i,j)}=∥f^{(m,0}(i,j)−g^{(m)}(i,j)∥² (19)

E_{0(i,j)}=∥f^{(m,s)}(i,j)−f^{(m,s-1)}(i,j)∥², (1≦i) (20)

for computing the submapping f^{(m,0)} and the submapping f^{(m,s)} at the m-th level, respectively.

In this manner, a mapping which keeps low the energy of all the submappings is obtained. Using the equation (20) makes the submappings corresponding to the different critical points associated to each other within the same level in order that the subimages can have high similarity. The equation (19) represents the distance between f^{(m,s)} (i,j) and the location where (i,j) should be mapped when regarded as a part of a pixel at the (m−1)the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)} (i,j). L is increased until such a pixel is found or L reaches its upper bound Lₘₐₓ^{(m)}. Lₘₐₓ^{(m)} is fixed for each level m. If no such a pixel is found at all, the third condition of the BC is ignored temporarily and such mappings that caused the area of the transformed quadrilateral to become zero (a point or a line) will be permitted so as to determine f^{(m,s)} (i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will be limited to the very small one, and only tiny changes in-the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

### [1.4] Automatic Determination of the Optimal Parameter Values

One of the main deficiencies of the existing image matching techniques lies in the difficulty of parameter adjustment. In most cases, the parameter adjustment is performed manually and it is extremely difficult to select the optical value. However, according to the base technology, the optimal parameter values can be obtained completely automatically.

The systems according to this base technology includes two parameters, namely, λ and η, where λ and η represent the weight of the difference of the pixel intensity and the stiffness of the mapping, respectively. The initial value for these parameters are 0. First, λ is gradually increased from λ=0 while η is fixed to 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena (1-4) are caused.

1. Pixels which should not be corresponded are erroneously corresponded only because their intensities are close.

2. As a result, correspondence between images becomes inaccurate, and the mapping becomes invalid.

3. As a result, D_{f}^{(m,s)} in the equation 14 tends to increase abruptly.

4. As a result, since the value of the equation 14 tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which the equation (14) takes the minimum value with λ being increased is kept. Such λ is determined as the optimal value at η=0. Then, the behavior of C_{f}^{(m,s)} is examined while η is incresed gradually, and η will be automatically determined by a method described later. λ will be determined corresponding to such the automatically determined η.

The above-described method resembles the focusing mechanism of human visual systems. In the human visual systems, the images of the respective right eye and left eye are matched while moving one eye. When the objects are clearly recognized, the moving eye is fixed.

### [1.4.1] Dynamic Determination of λ

λ is increased from 0 at a certain interval, and the a subimage is evaluated each time the value of λ changes. As shown in the equation (14), the total energy is defined by λC_{f}^{(m,s)}+D_{f}^{(m,s)}. D_{(i,j)}^{(m,s)} in the equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, that changing the mapping reduces the total energy is impossible unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(1), where h(1) is the number of pixels whose energy C_{(i,j)}^{(m,s)} is 1². In order that λ1²≧1, for example, the case of 1²=1/λ is considered. When λ varies from λ₁ to λ₂, a number of pixels (denoted A) expressed by the following (21)

$$\begin{matrix}A = {\sum }_{l = ⌈ \frac{1}{{λ}_{2}} ⌉}^{⌊ \frac{1}{{λ}_{1}} ⌋} h ( l ) ≅ {\int }_{l = \frac{1}{{λ}_{2}}}^{\frac{1}{{λ}_{1}}} h ( l ) d l \\ = - {\int }_{{λ}_{2}}^{{λ}_{1}} h ( l ) \frac{1}{{λ}^{3 / 2}} d λ \\ = {\int }_{{λ}_{1}}^{{λ}_{2}} \frac{h ( l )}{{λ}^{3 / 2}} d λ\end{matrix} \qquad ( 21 )$$

changes to a more stable state having the energy (22) which is

$${C}_{f}^{( m , s )} - {l}^{2} = {C}_{f}^{( m , s )} - \frac{1}{λ} . \qquad ( 22 )$$

Here, it is assumed that all the energy of these pixels is approximated to be zero. It means that the value of C_{(i,j)}^{(m,s)} changes by (23).

$$\partial {C}_{f}^{( m , s )} = - \frac{A}{λ} \qquad ( 23 )$$

As a result, the equation (24) holds.

$$\frac{\partial {C}_{f}^{( m , s )}}{\partial λ} = - \frac{h ( l )}{{λ}^{5 / 2}} \qquad ( 24 )$$

Since h(1)>0, C_{f}^{(m,s)} decreases in normal case. However, when λ tends to exceed the optimal value, the above phenomenon that is characterized by the increase in C_{f}^{(m,s)} occurs. The optimal value of λ is determined by detecting this phenomenon.

When

$$h ( l ) = {Hl}^{k} = \frac{H}{{λ}^{k / 2}} \qquad ( 25 )$$

is assumed where both H(h>0) and k are constants, the equation (26) holds.

$$\frac{\partial {C}_{f}^{( m , s )}}{\partial λ} = - \frac{H}{{λ}^{5 / 2 + k / 2}} \qquad ( 26 )$$

Then, if k≠−3, the following (27) holds.

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed p₀ here. In that case, since

$$\frac{\partial A}{\partial λ} = \frac{h ( l )}{{λ}^{3 / 2}} \qquad ( 28 )$$

holds, the number of pixels violating the BC increases at a rate of the equation (29).

$$\begin{matrix}{B}_{0} = \frac{h ( l ) {p}_{0}}{{λ}^{3 / 2}} \\ Thus , & ( 29 ) \\ \frac{{B}_{0} {λ}^{3 / 2}}{{p}_{0} h ( l )} = 1 & ( 30 )\end{matrix}$$

is a constant. If assumed that h(1)=H1^{k}, the following (31), for example,

B₀λ^{3/2+k/2}=p₀H (31)

becomes a constant. However, when λ exceeds the optimal value, the above value of (31) increases abruptly. By detecting this phenomenon, whether or not the value of B₀λ^{3/2+k/2}2^{m} exceeds an abnormal value B₀ₜₕᵣₑₛ exceeds is inspected, so that the optimal value of can be determined. Similarly, whether or not the value of B₁λ^{3/2+k/2}/2^{m} exceeds an abnormal value B₁ₜₕᵣₑₛ, so that the increasing rate B₁ of pixels violating the third condition of the BC is checked. The reason why the fact 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect the excessive distortion of the mapping which is failed to be detected through the observation of the energy C_{f}^{(m,s)}.

In the experimentation, the computation of f^{(m,s)} is stopped and then the computation of f^{(m,s+1)} is started when λ exceeded 0.1. That is because the computation of submappings is affected by the difference of mere 3 out of 255 levels in the pixel intensity when λ>0.1, and it is difficult to obtain a correct result when λ>0.1.

### [1.4.2] Histogram h(1)

The examination of C_{f}^{(m,s)} does not depend on the histogram h(1). The examination of the BC and its third condition may be affected by the h(1). k is usually close to 1 when (λ, C_{f}^{(m,s)}) is actually plotted. In the experiment, k=1 is used, that is, B₀λ² and B₁λ² are examined. If the true value of k is less than 1, B₀λ² and B₁λ² does not become constants and increase gradually by the factor of λ^{(1-k)/2}. If h(1) is a constant, the factor is, for example, λ^{1/2}. However, such a difference can be absorbed by setting the threshold B₀ₜₕᵣₑₛ appropriately.

Let us model the source image by a circular object with its center at(x₀,y₀) and its radius r, given by:

$$p ( i , j ) = \{ \begin{matrix}\frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( otherwise )\end{matrix} \qquad ( 32 )$$

and the destination image given by:

$$q ( i , j ) = \{ \begin{matrix}\frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( otherwise )\end{matrix} \qquad ( 33 )$$

with its center at(x₁,y₁) and radius r. Let c(x) has the form of c(x)=x^{k}. When the centers (x₀,y₀) and (x₁,y₁) are sufficiently far from each other, the histogram h(1) is then in the form of:

h(l)∝rl^{k}(k≠0) (34)

When k=1, the images represent objects with clear boundaries embedded in the backgrounds. These objects become darker toward their centers and brighter toward their boundaries. When k=−1, the images represent objects with vague boundaries. These objects are brightest at their centers, and become darker toward boundaries. Without much loss of generality, it suffices to state that objects in general are between these two types of objects. Thus, k such that −1≦k≦1 can cover the most cases, and it is guaranteed that the equation (27) is generally a decreasing function.

As can be observed from the above equation (34), attention must be directed to the fact that r is influenced by the resolution of the image, namely, r is proportional to 2^{m}. That is why the factor 2^{m} was introduced in the above section [1.4.1].

### [1.4.3] Dynamic Determination of η

The parameter η can also be automatically determined in the same manner. Initially, η is set to zero, and the final mapping f⁽ⁿ⁾ and the energy C_{f}⁽ⁿ⁾ at the finest resolution are computed. Then, after n is increased by a certain value Δη and the final mapping f⁽ⁿ⁾ and the energy C_{f}⁽ⁿ⁾ at the finest resolution are again computed. This process is repeated until the optimal value is obtained. η represents the stiffness of the mapping because it is a weight of the following equation (35).

E_{0(i,j)}^{(m,s)}=∥f^{(m,s)}(i,j)−f^{(m,s-1)}(i,j)∥² (35)

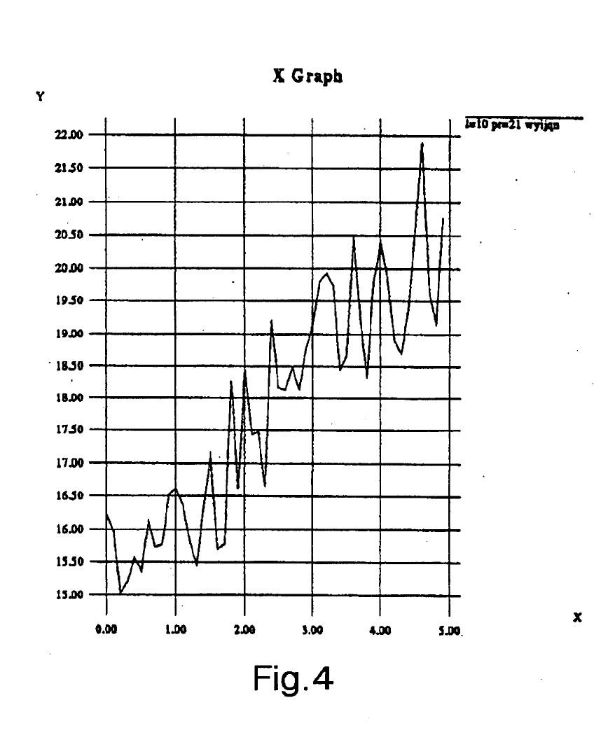

When η is zero, D_{f}⁽ⁿ⁾ is determined irrespective of the previous submapping, and the present submapping would be elastically deformed and become too distorted. On the other hand, when η is a very large value, D_{f}⁽ⁿ⁾ is almost completely f determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of n which minimizes C_{f}⁽ⁿ⁾ can be obtained in this manner. However, since various elements affects the computation compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of λ. Thus, whether the obtained value of C_{f}⁽ⁿ⁾ is the minimum or not cannot be judged instantly. When candidates for the minimum value are found, the true minimum needs to be searched by setting up further finer interval.

### [1.5] Supersampling

When deciding the correspondence between the pixels, the range of f^{(m,s)} can be expanded to R×R (R being the set of real numbers) in order to increase the degree of freedom. In this case, the intensity of the pixels of the destination image is interpolated, so that f^{(m,s)} having the intensity at non-integer points

V(q_{f}_{^{(m,s)}}_{(i,j)}^{(m,s)}) (36)

is provided. Namely, supersampling is performed. In its actual implementation, f^{(m,s)} is allowed to take integer and half integer values, and

V(q_{(i,j)+(0.5,0.5)}^{(m,s)}) (37)

is given by

(V(q_{(i,j)}^{(m,s)})+V(q_{(i,j)+(1,1)}^{(m,s)}))/2 (38)

### [1.6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} relating the intensity, thus making it difficult to perform the correct evaluation.

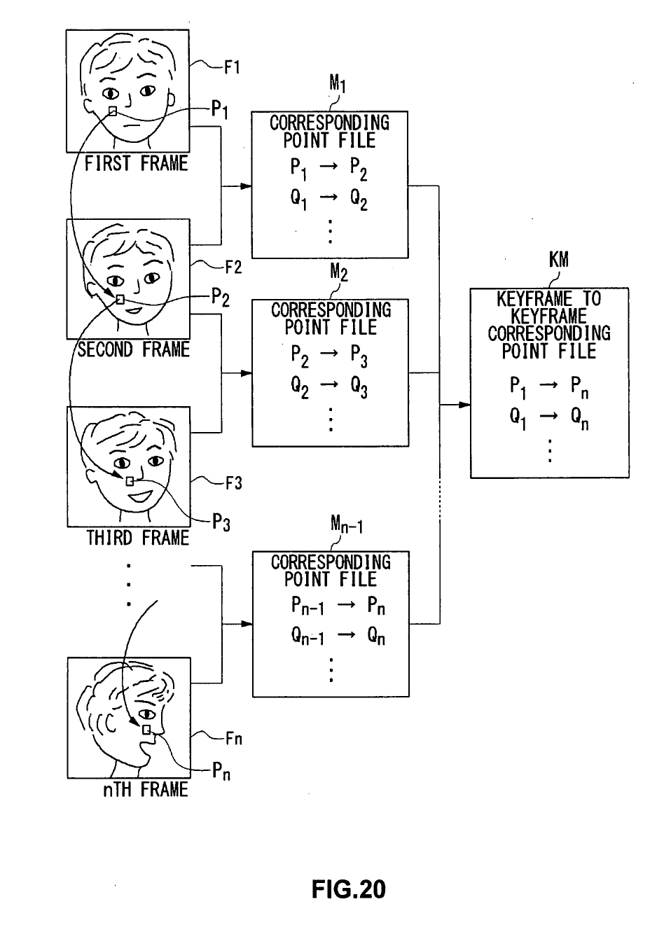

For example, the matching between a human face and a cat's face is computed as shown in FIGS. 20(a) and 20(b). The cat's face is covered with hair and is a mixture of very bright pixels and very dark pixels. In this case, in order to compute the submappings of the two faces, its subimages are normalized. Namely, the darkest pixel intensity is set to 0 while the brightest pixel intensity is set to 255, and other pixel intensity values are obtained using the linear interpolation.

### [1.7] Implementation

In the implementation, utilized is a heuristic method where the computation proceeds linearly as the source image is scanned. First, the value of f^{(m,s)} is determined at the top leftmost pixel (i,j)=(0,0). The value of each f^{(m,s)} (i,j) is then determined while i is increased by one at each step. When i reaches the width of the image, j is increased by one and i is reset to zero. Thereafter, f^{(m,s)} (i,j) is determined while scanning the source image. Once pixel correspondence is determined for all the points, it means that a single mapping f^{(m,s)} is determined.

When a corresponding point q_{f(i,j)} is determined for p_{(i,j)}, a corresponding point q_{f(i,j+1)} of p(_{i,j+1)} is determined next. The position of q_{f(i,j+1)} is constrained by the position of q_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, it is determined starting from the top rightmost location while decreasing i and increasing j. When (s mod 4) is 2, it is determined starting from the bottom rightmost location while decreasing both i and j. When (s mod 4) is 3, it is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In the actual implementation, the values of f^{(m,s)}(i,j) (m=1, . . . ,n) that satisfy the BC are chosen as much as possible, from the candidates (k,1) by awarding a penalty to the candidates violating the BC. The energy D_{(k,1)} of the candidate that violates the third condition of the BC is multiplied by Φ and that of a candidate that violates the first or second condition of the BC is multiplied by φ. In the actual implementation, Φ=2 and φ=100000 are used.

In order to check the above-mentioned BC, the following test is performed as the actual procedure when determining (k,1)=f^{(m,s)} (i,j). Namely, for each grid point (k,1) in the inherited quadrilateral of f^{(m,s)} (i,j), whether or not the z-component of the outer product of

$$W = {A}^{ρ} \times {B}^{ρ} \qquad ( 39 )$$

is equal to or greater than 0 is examined, where

$$\begin{matrix}{A}^{ρ} = \vec{{q}_{{f}^{( m , s )} ( i , j - 1 )}^{( m , s )} {q}_{{f}^{( m , s )} ( i + 1 , j + 1 )}^{( m , s )}} & ( 40 ) \\ {B}^{ρ} = \vec{{q}_{{f}^{( m , s )} ( i , j - 1 )}^{( m , s )} {q}_{{f}_{( k , l )}}^{( m , s )}} & ( 41 )\end{matrix}$$

Here, the vectors are regarded as 3D vectors and the z-axis is defined in the orthogonal right-hand coordinate system. When W is negative, the candidate is awarded a penalty by multiplying D_{(k,j)}^{(m,s) b}y φ so as not to be selected as much as possible.

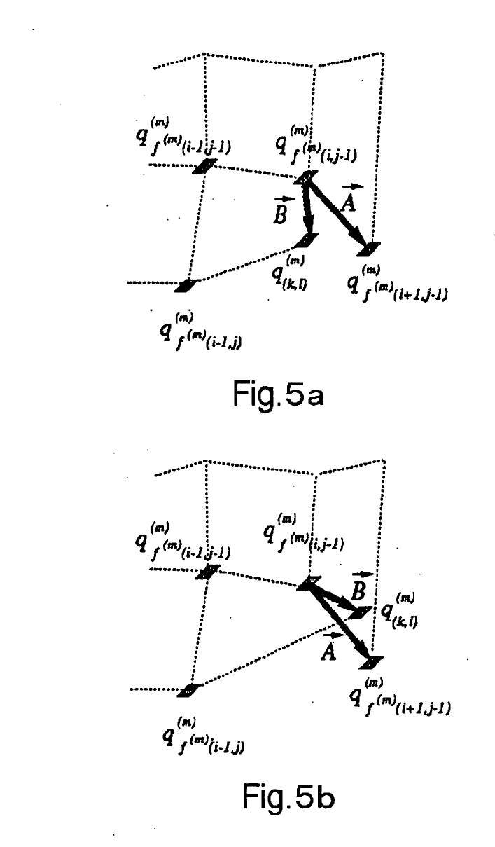

FIGS. 5(a) and 5(b) illustrate the reason why this condition is inspected. FIG. 5(a) shows a candidate without a penalty and FIG. 5(b) shows one with a penalty. When determining the mapping f^{(m,s)} (i,j+1) for the adjacent pixel at (i,j+1), there is no pixel on the source image plane that satisfies the BC if the z-component of W is negative because then q_{(k,1)}^{(m,s)} passes the boundary of the adjacent quadrilateral.

### [1.7.1] The Order of Submappings

In the actual implementation, σ (0)=0, σ (1)=1, σ (2)=2, σ (3)=3, σ (4)=3 were used when the resolution level was even, while σ (0)=3, σ (1)=2, σ (2)=1, σ (3)=0, σ (4)=3 were used when the resolution level was odd. Thus, the submappings are shuffled in an approximately manner. It is to be noted that the submapping is primarily of four types, and s may be any one among 0 to 3. However, a processing with s=4 was actually performed for the reason described later.

### [1.8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1,j+1,)}p_{(i,j+1)} on the source image plane is mapped to a quadrilateral q_{f(i,j)}q_{f(i+1,j)}q_{f(i+1,j+1)}q_{f(i,j+1)} on the destination image plane. For simplicity, the distance between the image planes is assumed 1. The intermediate image pixels r(x,y,t) (0≦x≦N−1, 0≦y≦M−1) whose distance from the source image plane is t (0≦t≦1) are obtained as follows. First, the location of the pixel r(x,y,t), where x,y,tεR, is determined by the equation (42).

$$\begin{matrix}( x , y ) = ( 1 - dx ) ( 1 - dy ) ( 1 - t ) ( i , j ) + ( 1 - dx ) ( 1 - dy ) tf ( i , j ) + \\ dx ( 1 - dy ) ( 1 - t ) ( i + 1 , j ) + dx ( 1 - dy ) tf ( i + 1 , j ) + \\ 1 - dx ) dy ( 1 - t ) ( i , j + 1 ) + ( 1 - dx ) dytf ( i , j + 1 ) + \\ dxdy ( 1 - t ) ( i + 1 , j + 1 ) + dxdytf ( i + 1 , j + 1 )\end{matrix} \qquad ( 42 )$$

The value of the pixel intensity at r(x,y,t) is then determined by the equation (43).

$$\begin{matrix}V ( r ( x , y , t ) ) = 1 - dx ) ( 1 - dy ) ( 1 - t ) V ( {p}_{( i , j )} ) + \\ ( 1 - dx ) ( 1 - dy ) tV ( {q}_{f ( i , j )} ) + \\ dx ( 1 - dy ) ( 1 - t ) V ( {p}_{( i + 1 , j )} ) + \\ dx ( 1 - dy ) tV ( {q}_{f ( i + 1 , j )} ) + \\ ( 1 - dx ) dy ( 1 - t ) V ( {p}_{( i , j + 1 )} ) + \\ ( 1 - dx ) dytV ( {q}_{f ( i , j + 1 )} ) + \\ dxdy ( 1 - t ) V ( {p}_{( i + 1 , j + 1 )} ) + dxdytV ( {q}_{f ( i + 1 , j + 1 )} )\end{matrix} \qquad ( 43 )$$

where dx and dy are parameters varying from 0 to 1.

### [1.9] Mapping to Which Constraints are Imposed

So far, the determination of the mapping to which no constraint is imposed has been described. However, when a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination images and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of the specified pixels are mapped to the locations near the position to which the specified one is mapped. Here, the approximate mapping at the m-th level in the resolution hierarchy is denoted by F^{(m)}.

The approximate mapping F is determined in the following manner. First, the mapping for several pixels are specified. When nₛ pixels

p(i₀,j₀),p(i₁,j₁), . . . ,p(iₙ_{ₛ}₋₁,jₙ_{ₛ}₋₁) (44)

of the source image are specified, the following values in the equation (45) are determined.

F⁽ⁿ⁾(i₀,j₀)=(k₀,l₀),

F⁽ⁿ⁾(i₁,j₁)=(k₁,l₁), . . . , (45)

F⁽ⁿ⁾(iₙ_{ₛ}₋₁,jₙ_{ₛ}₋₁)=(k₁,lₙ_{ₛ}₋₁)

For the remaining pixels of the source image, the amount of displacement is the weighted average of the displacement of p(iₕ, jₕ) (h=0, . . . , nₛ−1). Namely, a pixel p_{(i,j)} is mapped to the following pixel (expressed by the equation (46)) of the destination image.

$$\begin{matrix}{F}^{( m )} ( i , j ) = \frac{( i , j ) + {\sum }_{h = 0}^{h = {n}_{s} - 1} ( {k}_{h} - {i}_{h} , {l}_{h} - {j}_{h} ) {weight}_{h} ( i , j )}{{2}^{n - m}} \\ where & ( 46 ) \\ {weight}_{h} ( i , j ) = \frac{1 / {‖ ( {i}_{h} - i , {j}_{h} - j ) ‖}^{2}}{total\_weight ( i , j )} \\ where & ( 47 ) \\ total\_weight ( i , j ) = {\sum }_{h = 0}^{h = {n}_{s} - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that mapping f similar to F^{(m)} has a lower energy. Precisely speaking, D_{(i,j)}^{(m,s)} is expressed by the equation (49).

$$\begin{matrix} {D}_{( i , j )}^{( m , s )} = {E}_{{0}_{( i , j )}}^{( m , s )} + η {E}_{{1}_{( i , j )}}^{( m , s )} + κ {E}_{{2}_{( i , j )}}^{( m , s )} & ( 49 ) \\ {E}_{{2}_{( i , j )}}^{( m , s )} = \{ \begin{matrix}0 , & if {‖ \begin{matrix}{F}^{( m )} ( i , j ) - \\ {f}^{( m , s )} ( i , j )\end{matrix} ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & otherwise\end{matrix} & ( 50 )\end{matrix}$$

where κ, ρ≧0. Finally, the mapping f is completely determined by the above-described automatic computing process of mappings.

Note that E₂_{_{(i,j}}^{(m,s)} becomes 0 if f^{(m,s)} (i,j) is sufficiently close to F^{(m)} (i,j) i.e., the distance therebetween is equal to or less than

$$⌊ \frac{{ρ}^{2}}{{2}^{2 ( n - m )}} ⌋ \qquad ( 51 )$$

It is defined so because it is desirable to determine each value f^{(m,s)} (i,j) automatically to fit in an appropriate place in the destination image as long as each value f^{(m,s)} (i,j) is close to F^{(m)} (i,j). For this reason, there is no need to specify the precise correspondence in detail, and the source image is automatically mapped so that the source image matches the destination image.

### [2] Concrete Processing Procedure

The flow of the process utilizing the respective elemental techniques described in [1] will be described.

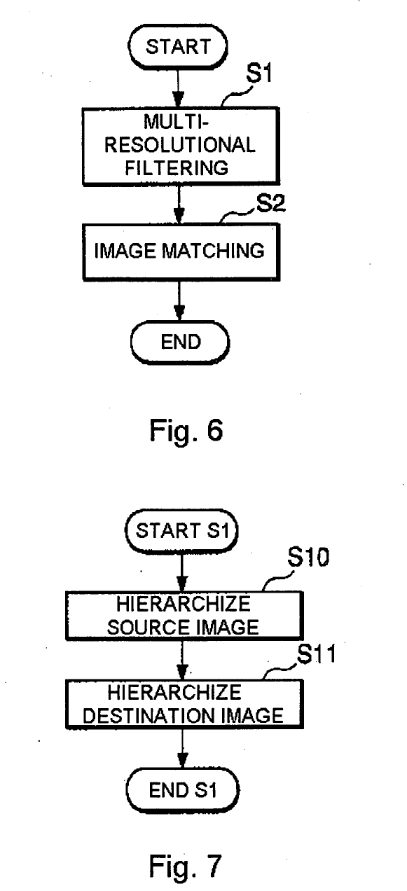

FIG. 6 is a flowchart of the entire procedure of the base technology. Referring to FIG. 6, a processing using a multiresolutional critical point filter is first performed (S1). A source image and a destination image are then matched (S2). S2 is not indispensable, and other processings such as image recognition may be performed instead, based on the characteristics of the image obtained at S1.

FIG. 7 is a flowchart showing the details of the process at S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel.

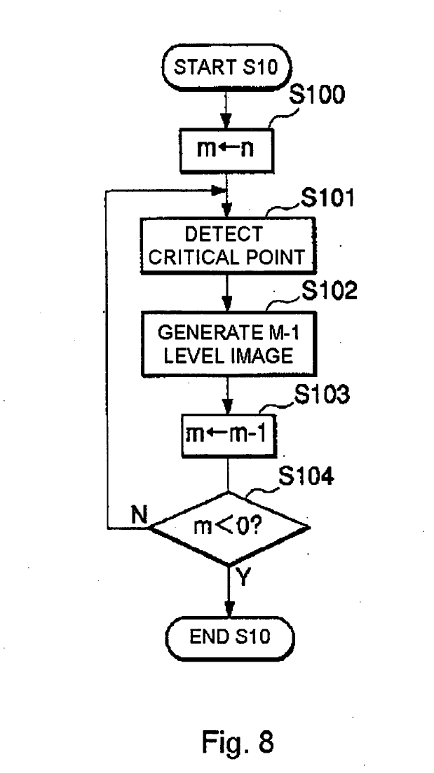

FIG. 8 is a flowchart showing the details of the process at S10 shown in FIG. 7. Suppose that the size of the original source image is 2ⁿ×2ⁿ. Since source hierarchical images are sequentially generated from one with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{(m-1,2)} and p^{(m-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

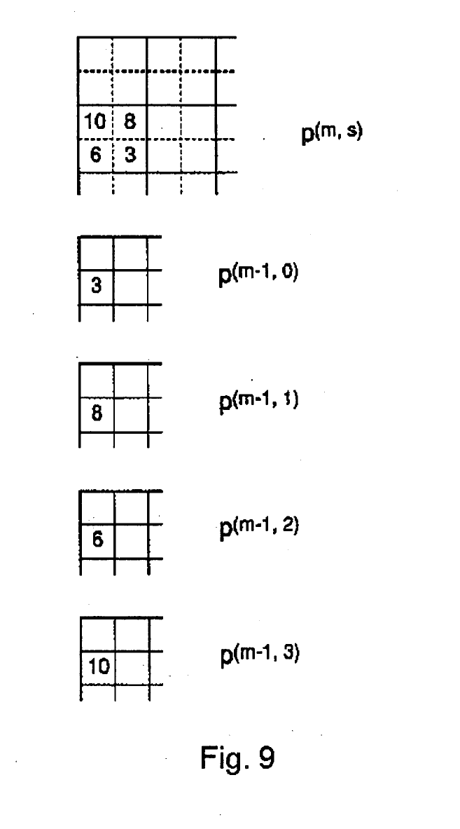

FIG. 9 shows correspondence between partial images of the m-th and those of (m−1)th levels of resolution. Referring to FIG. 9, respective values represent the intensity of respective pixels. p^{(m,s)} symbolizes four images p(m,0) through p^{(m,3)}, and when generating p^{(m-1,0)}, p^{(m,s)} is regarded as p^{(m,0)}. For example, as for the block shown in FIG. 9, comprising four pixels with their pixel intensity values indicated inside, images p^{(m-1,0)}, p^{(m-1,1)}, p^{(m-1,2)} and p^{(m-1,3)} acquire “3”, “8”, “6” and “10”, respectively, according to the rules described in [1.2]. This block at the m-th level is replaced at the (m−1)th level by respective single pixels acquired thus. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

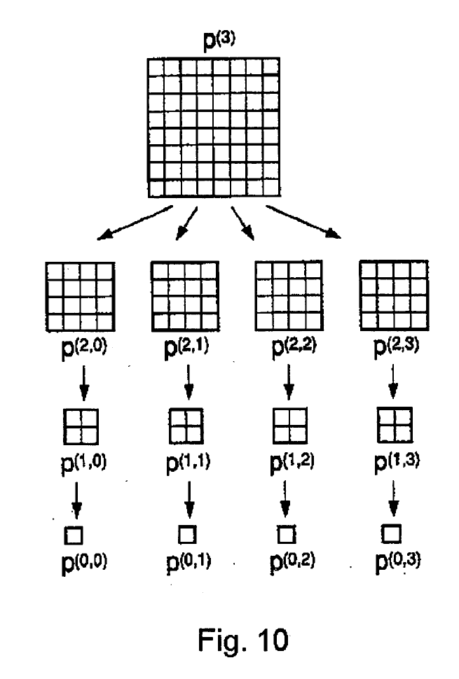

FIG. 10 shows source hierarchical images generated at S10 in the case of n=3. The initial source image is the only image common to the four series followed. The four types of subimages are generated independently, depending on the type of a critical point. Note that the process in FIG. 8 is common to S11 shown in FIG. 7, and that destination hierarchical images are generated through the similar procedure. Then, the process by S1 shown in FIG. 6 is completed.

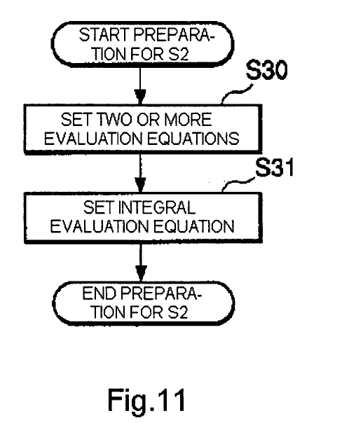

In the base technology, in order to proceed to S2 shown in FIG. 6 a matching evaluation is prepared. FIG. 11 shows the preparation procedure. Referring to FIG. 11, a plurality of evaluation equations are set (S30). Such the evaluation equations include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such the combined evaluation equation includes λC_{(i,j)}^{(m,s)}+D_{f}^{(m,s)}. Using η introduced in [1.3.2.2], we have

ΣΣ(λC_{(i,j)}^{(m,s)}+ηE_{0(i,j)}^{(m,s)}+E_{1(i,j)}^{(m,s)}) (52)

In the equation (52) the sum is taken for each i and j where i and j run through 0, 1, . . . , 2^{m-1}. Now, the preparation for matching evaluation is completed.

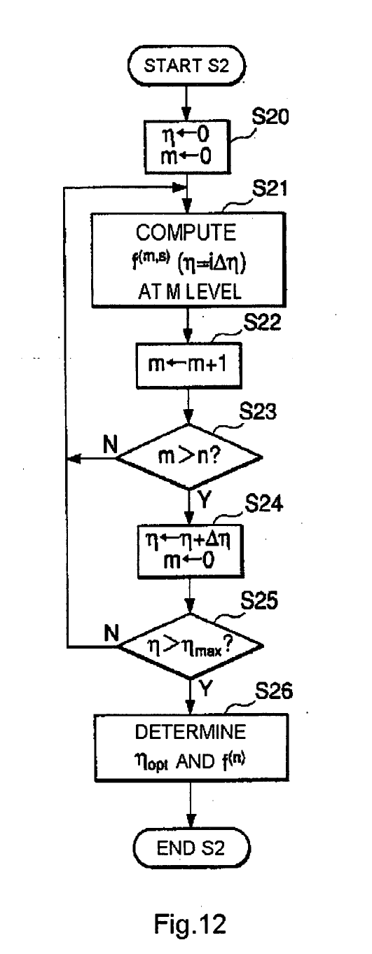

FIG. 12 is a flowchart showing the details of the process of S2 shown in FIG. 6. As described in [1], the source hierarchical images and destination hierarchical images are matched between images having the same level of resolution. In order to detect global corresponding correctly, a matching is calculated in sequence from a coarse level to a fine level of resolution. Since the source and destination hierarchical images are generated by use of the critical point filter, the location and intensity of critical points are clearly stored even at a coarse level. Thus, the result of the global matching is far superior to the conventional method.

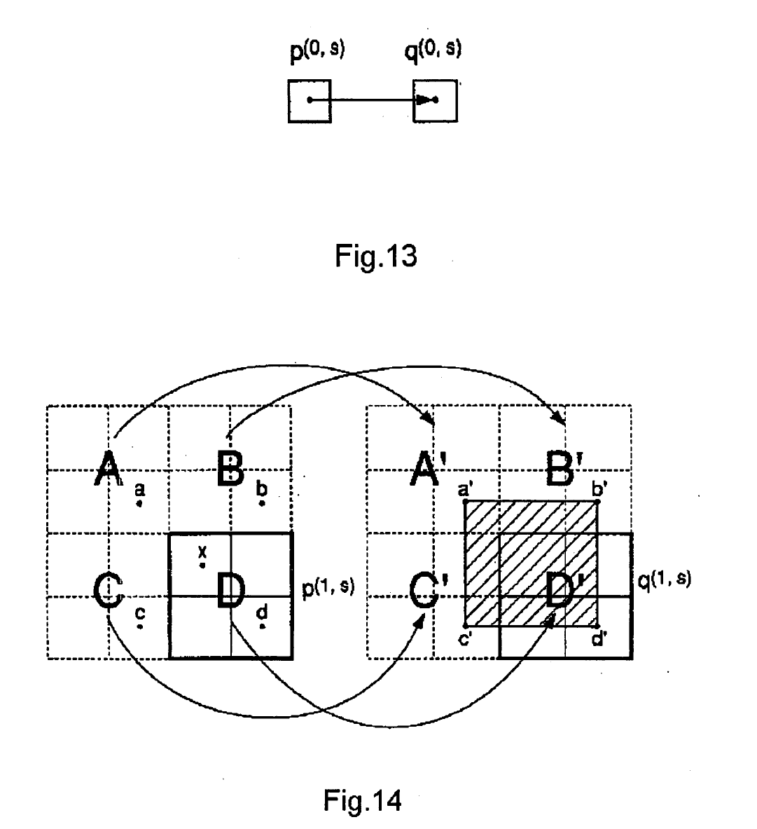

Referring to FIG. 12, a coefficient parameter n and a level parameter m are set to 0 (S20). Then, a matching is computed between respective four subimages at the m-th level of the source hierarchical images and those of the destination hierarchical images at the m-th level, so that four types of submappings f^{(m,s)} (s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is a vertical reference between different levels. If m=0, there is no coarser level and the process, but this exceptional process will be described using FIG. 13.

On the other hand, a horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one is referred to since there is no other submapping at the same level to be referred to as shown in the equation (19). In the experiment, however, a procedure is adopted such that after the submappings were obtained up to f^{(m,3)}, f^{(m,0)} is renewed once utilizing the thus obtained subamppings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is consitituted by a single pixel, the four submappings f^{(0,s)} is automatically chosen as the identity mapping. FIG. 14 shows how the submappings are determined at the first level. At the first level, each of the sub-images is constituted of four pixels, which are indicated by a solid line. When a corresponding point (pixel) of the point (pixel) x in p^{(1,s)} is searched within q^{(1,s)}, the following procedure is adopted.

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the points A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the upper right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum En the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾ (η=0) because it has been determined relative to η=0.

Next, to obtain the mapping with respect to other different η, η is shifted by Δη and m is reset to zero (S24). After confirming that new η does not exceed a predetermined search-stop value ηₘₐₓ (S25), the process returns to S21 and the mapping f⁽ⁿ⁾ (η=Δη) relative to the new η is obtained. This process is repeated while obtaining f⁽ⁿ⁾ (η=iΔη) (i=0,1, . . . ) at S21. When η exceeds ηₘₐₓ, the process proceeds to S26 and the optimal η=ηₒₚₜ is determined using a method described later, so as to let f⁽ⁿ⁾ (η=ηₒₚₜ) be the final mapping f⁽ⁿ⁾.

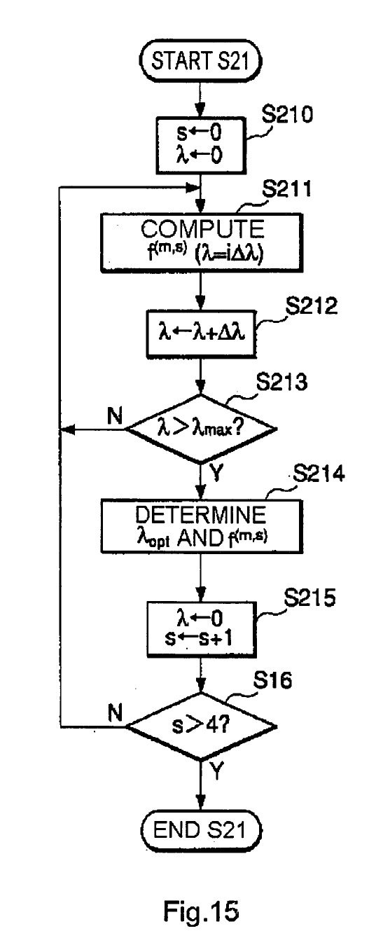

FIG. 15 is a flowchart showing the details of the process of S21 shown in FIG. 12. According to this flowchart, the submappings at the m-th level are determined for a certain predetermined η. When determining the mappings, the optimal λ is defined independently for each submapping in the base technology.

Referring to FIG. 15, s and λ are first reset to zero (S210). Then, obtained is the submapping f^{(m,s)} that minimizes the energy with respect to the then λ (and, implicitly, η) (S211), and the thus obtained is denoted as f^{(m,s)} (λ=0). In order to obtain the mapping with respect to other different λ, λ is shifted by Δλ. After confirming that new λ does not exceed a predetermined search-stop value λₘₐₓ (S213), the process returns to S211 and the mapping f^{(m,s)} (λ=Δλ) relative to the new λ is obtained. This process is repeated while obtaining f^{(m,s)} (λ=iΔλ)(i=0,1 . . . ). When λ exceeds λₘₐₓ, the process proceeds to S214 and the optimal λ=λₒₚₜ is determined, so as to let f⁽ⁿ⁾ (λ=λₒₚₜ) be the final mapping f^{(m,s)} (S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

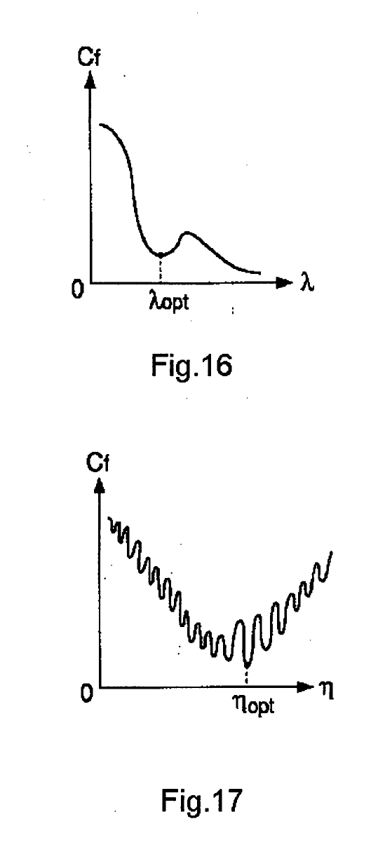

FIG. 16 shows the behavior of the energy C_{f}^{(m,s)} corresponding to f^{(m,s)} (λ=iΔλ) (i=0,1, . . . ) for a certain m and s while varying λ. Though described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} turns to decrease again in the range λ>λₒₚₜ, the mapping will be spoiled by then and becomes meaningless. For this reason, it suffices to pay attention to the first occurring minima value. λₒₚₜ is independently determined for each submapping including f⁽ⁿ⁾.

FIG. 17 shows the behavior of the energy C_{f}⁽ⁿ⁾ corresponding to f⁽ⁿ⁾(η=iΔλ) (i=0,1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to the object recognition, characteristic extraction, and image matching. As a result, it is possible to construct an image processing system which significantly reduces manual labors.

Some extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ in the base technology or more than two parameters. When there are more than three parameters used, they are determined while changing one at a time.

(2) In the base technology, a parameter is determined in such a manner that a point at which the evaluation equation C_{f}^{(m,s)} constituting the combined evaluation equation takes the minima is detected after the mapping such that the value of the combined evaluation equation becomes minimum is determined. However, instead of this two-step processing, a parameter may be effectively determined, as the case may be, in a manner such that the minimum value of a combined evaluation equation becomes minimum. In that case, αE₀+βE₁, for instance, may be taken up as the combined evaluation equation, where α+β=1 is imposed as a constraint so as to equally treat each evaluation equation. The essence of automatic determination of a parameter boils down to determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes ¼. However, it is possible to suppose that one block consists of 3×3 pixels and critical points are searched in this 3×3 block, then the number of pixels will be 1/9 as the level advances by one.

When the source and the destination images are color images, they are first converted to monochrome images, and the mappings are then computed. The source color images are then transformed by using the mappings thus obtained as a result thereof. As one of other methods, the submappings may be computed regarding each RGB component.

### [3] Improvements in the Base Technology

Based on the technology mentioned above, some improvements are made to yield the higher preciseness of matching. Those improvements are thereinafter described.

### [3.1] Critical Point Filters and Subimages Considering Color Information

For the effective utilization of the color information in the images, the critical point filters are revised as stated below. First, HIS, which is referred to be closest to human intuition, is introduced as color space, and the formula which is closest to the visual sensitivity of human is applied to the transformation of color into intensity, as follows.

$$H = \frac{\frac{π}{2} - {tan}^{- 1} ( \frac{2 R - G - R}{\sqrt{3 ( G - B )}} )}{2 π} \\ I = \frac{R + G + B}{3} \\ S = 1 - \frac{min ( R , G , B )}{3} \\ Y = 0.299 \times R + 0.587 \times G + 0.114 \times B \qquad ( 53 )$$

Here, the following definition is made, in which the intensity Y and the saturation S at the pixel a are respectively denoted by Y(a) and S(a).

$${α}_{Y} ( a , b ) = \{ \begin{matrix}a Λ ( Y ( a ) \leq Y ( b ) ) \\ b Λ ( Y ( a ) > Y ( b ) )\end{matrix} \\ {β}_{Y} ( a , b ) = \{ \begin{matrix}a Λ ( Y ( a ) \geq Y ( b ) ) \\ b Λ ( Y ( a ) < Y ( b ) )\end{matrix} \\ {β}_{S} ( a , b ) = \{ \begin{matrix}a Λ ( S ( a ) \geq S ( b ) ) \\ b Λ ( S ( a ) < S ( b ) )\end{matrix} \qquad ( 54 )$$

Following five filters are prepared by means of the definition described above.

p_{(i,j)}^{(m,0)}=β_{Y}(β_{Y}(p_{(2i,2j)}^{(m+1,0)},p_{(2i,2j+1)}^{(m+1,0)}), β_{Y}(p_{(2i,+1,2j)}^{(m+1,0)},p_{2i+1,2j+1)}^{(m+1,0)}))

p_{(i,j)}^{(m,1)}=α_{Y}(β_{Y}(p_{(2i,2j)}^{(m+1,1)},p_{2i,2j+1)}^{(m+1,1)}), β_{Y}(p_{(2i,+1,2j)}^{(m+1,1)},p_{(2i+1,2j+1)}^{(m+1,1)}))

p_{(i,j)}^{(m,2)}=β_{Y}(α_{Y}(p_{2i,2j)}^{(m+1,2)},p_{(2i,2j+1)}^{(m+1,2)}), α_{Y}(p_{(2i+1,2j)}^{(m+1,2)},p_{(2i+1,2j+1)}^{(m+1,2)}))

p_{(i,j}^{(m,3)}=α_{Y}(α_{Y}(p_{(2i,2j)}^{(m+1,3)},p_{(2i,2j+1)}^{(m+1,3)}), α_{Y}(p_{(2i+1,2j)}^{(m+1,3)},p_{(2i+1,2j+1)}^{(m+1,3)}))

p_{(i,j)}^{(m,4)}=β_{S}(β_{S}(p_{(2i,2j)}^{(m+1,4)},p_{(2i,2j+1)}^{(m+1,4)}), β_{S}(p_{2i+1,2j)}^{(m+1,4)},p_{(2i+1,2j+1)}^{(m+1,4)})) (55)

The four filters from the top to the fourth in (55) are almost the same as those in the base technology, and the critical point of intensity is preserved with the color information. The last filter preserves the critical point of saturation, with the color information, too.

At each level of the resolution, five types of subimage are generated by these filters. Note that the subimages at the highest level consist with the original image.

p_{(i,j)}^{(n,0)}=p_{(i,j)}^{(n,1)}=p_{(i,j)}^{(n,2)}=p_{(i,j)}^{(n,3)}=p_{(i,j)}^{(n,4)}=p_{(i,j)} (56)

### [3.2] Edge Images and Subimages

By way of the utilization of the information related to intensity derivation (edge) for matching, the edge detection filter by first order derivative is introduced. This filter can be obtained by convolution integral with a given operator H.

p_{(i,j)}^{(n,h)}=Y(p_{(i,j)}) [symbol] Hₕ (57)

p_{(i,j)}^{(n,v)}=Y(p_{(i,j)}) [symbol] Hᵥ

In this improved base technology, the operator described below is adopted as H, in consideration of the computing speed.

$${H}_{h} = \frac{1}{4} [ \begin{matrix}1 & 0 & - 1 \\ 2 & 0 & - 2 \\ 1 & 0 & - 1\end{matrix} ] \\ {H}_{v} = \frac{1}{4} [ \begin{matrix}1 & 2 & 1 \\ 0 & 0 & 0 \\ - 1 & - 2 & - 1\end{matrix} ] \qquad ( 58 )$$

Next, the image is transformed into the multiresolution hierarchy. Because the image generated by the filter has the intensity of which the center value is 0, the most suitable subimages are the mean value images as follows.

$${p}_{( i , j )}^{( m , h )} = \frac{1}{4} ( {p}_{( 2 i , 2 j )}^{( m + 1 , h )} + {p}_{( 2 i , 2 j + 1 )}^{( m + 1 , h )} + {p}_{( 2 i + 1 , 2 j )}^{( m + 1 , h )} + {p}_{( 2 i + 1 , 2 j + 1 )}^{( m + 1 , h )} ) \\ {p}_{( i , j )}^{( m , v )} = \frac{1}{4} ( {p}_{( 2 i , 2 j )}^{( m + 1 , v )} + {p}_{( 2 i , 2 j + 1 )}^{( m + 1 , v )} + {p}_{( 2 i + 1 , 2 j )}^{( m + 1 , v )} + {p}_{( 2 i + 1 , 2 j + 1 )}^{( m + 1 , v )} ) \qquad ( 59 )$$

The images described in (59) are introduced to the energy function for the computing in the “forward stage”, that is, the stage in which an initial submapping is derived, as will hereinafter be described in detail.

The magnitude of the edge, i.e., the absolute value is also necessary for the calculation.

p_{(i,j)}^{(n,c)}={square root over ((p_{(i,j)}^{(n,h)})²+(p_{(i,j)}^{(n,v)})²)} (60)

Because this value is constantly positive, the filter of maximum value is used for the transformation into the multiresolutional hierarchy.

p_{(i,j)}^{(m,e)}=β_{Y}(β_{Y}(p_{(2i,2j)}^{(m+1,e)},p_{(2i,2j+1)}^{(m+1,e)}), β_{Y}(p_{(2i+1,2j)}^{(m+1,e)},p_{(2i+1,2y+1)}^{(m+1,e)})) (61)

The image described in (61) is introduced in the course of determining the order of the calculation in the “forward stage” described later.

### [3.3] Computing Procedures

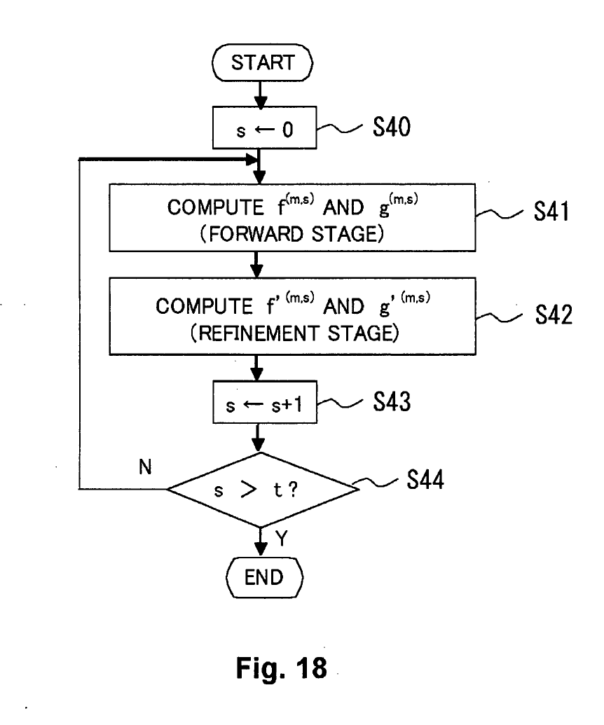

The computing proceeds in order from the subimages with the coarsest resolution. The calculation is performed more than once at each level of the resolution due to the five types of subimages. This is referred to as “turn”, and the maximum number of times is denoted by t. Each turn is constituted with the energy minimization calculations both in the forward stage mentioned above, and the “refinement stage”, that is, the stage in which the submapping is computed again. FIG. 18 shows the flowchart related to the improved part of the computing which determines the submapping at the m-th level.

As shown in the figure, s is set to zero (S40) initially. Then the mapping f^{(m,s)} of the source image to the destination image is computed by the energy minimization in the forward stage (S41). The energy minimized here is the linear sum of the energy C, concerning the value of the corresponding pixels, and the energy D, concerning the smoothness of the mapping.

The energy C is constituted with the energy C_{I} concerning the intensity difference, which is the same as the energy C in the base technology shown in [1] and [2], the energy C_{C} concerning the hue and the saturation, and the energy C_{E} concerning the difference of the intensity derivation (edge). These energies are respectively described as follows.

$${C}_{I}^{f} ( i , j ) = {\vert Y ( {p}_{( i , j )}^{( m , σ ( t ) )} ) - Y ( {q}_{f ( i , j )}^{( m , σ ( t ) )} ) \vert}^{2} \\ {C}_{C}^{f} ( i , j ) = {\vert \begin{matrix}S ( {p}_{( i , j )}^{( m , σ ( t ) )} ) cos ( 2 π H ( {p}_{( i , j )}^{( m , σ ( t ) )} ) ) - \\ S ( {q}_{f ( i , j )}^{( m , σ ( t ) )} ) cos ( 2 π H ( {q}_{f ( i , j )}^{( m , σ ( t ) )} ) )\end{matrix} \vert}^{2} + {\vert \begin{matrix}S ( {p}_{( i , j )}^{( m , σ ( t ) )} ) sin ( 2 π H ( {p}_{( i , j )}^{( m , σ ( t ) )} ) ) - \\ S ( {q}_{f ( i , j )}^{( m , σ ( t ) )} ) sin ( 2 π H ( {q}_{f ( i , j )}^{( m , σ ( t ) )} ) )\end{matrix} \vert}^{2} \\ {C}_{E}^{f} = {\vert {p}_{( i , j )}^{( m , h )} - {q}_{f ( i , j )}^{( m , h )} \vert}^{2} + {\vert {p}_{( i , j )}^{( m , v )} - {q}_{f ( i , j )}^{( m , v )} \vert}^{2} \qquad ( 62 )$$

The energy D introduced here is the same as that in the base technology before the improvement, shown above. However, in that technology, only the next pixel is taken into account when the energy El, which guarantees the smoothness of the images, is derived. On the other hand, the number of the ambient pixels taken into account can be set as a parameter d, in this improved technology.

$${E}_{0}^{f} ( i , j ) = {‖ f ( i , j ) - ( i , j ) ‖}^{2} \\ {E}_{1}^{f} ( i , j ) = {\sum }_{{i}^{′} = i - d}^{i + d} {\sum }_{{j}^{′} = j - d}^{j + d} {‖ \begin{matrix}( f ( i , j ) - ( i , j ) ) - \\ ( f ( {i}^{′} , {j}^{′} ) - ( {i}^{′} , {j}^{′} ) )\end{matrix} ‖}^{2} \qquad ( 63 )$$

In preparation for the next refinement stage, the mapping g^{(m,s)} of the destination image q to the source image p is also computed in this stage.

In the refinement stage (S42), more appropriate mapping f′^{(m,s)} is computed based on the bidirectional mapping, f^{(m,s)} and g^{(m,s)}, which is previously computed in the forward stage. The energy minimization calculation for the energy M, which is defined newly, is performed here. The energy M is constituted with the degree of conformation to the mapping g of the destination image to the source image, M₀, and the difference from the initial mapping, M₁.

M₀^{f′}(i,j)=∥g(f′(i,j))−(i,j)∥² (64)

M₁^{f′}(i,j)=∥f′(i,j)−f(i,j)∥²

The mapping g′^{(m,s)} of the destination image q to the source image p is also computed in the same manner, so as not to distort the symmetry.

Thereafter, s is incremented (S43), and when it is confirmed that s does not exceed t (S44), the computation proceeds to the forward stage in the next turn (S41). In so doing, the energy minimization calculation is performed using a substituted E₀, which is described below.

E₀^{f}(i,j)=∥f(i,j)−f′(i,j)∥² (65)

### [3.4] Order of Mapping Calculation

Because the energy concerning the mapping smoothness, E₁, is computed using the mappings of the ambient points, the energy depends on whether those points are previously computed or not. Therefore, the total mapping preciseness significantly changes depending on the point from which the computing starts, and the order. So the image of the absolute value of edge is introduced. Because the edge has a large amount of information, the mapping calculation proceeds from the point at which the absolute value of edge is large. This technique can make the mapping extremely precise, in particular, for binary images and the like.

### Embodiment Related to Concatenation

A description will now be given of an embodiment relating to concatenation we proposed in an earlier application. In this embodiment, adjacent image frames, of the entirety of consecutive image frames, are subject to matching computation so as to generate corresponding point information for each pair of adjacent image frames. The plurality of sets of corresponding point information are combined into a single set of corresponding point information, with the result that corresponding point information on image frames that are not adjacent to each other is generated. We will refer to this process as concatenation. Concatenation is capable of obtaining more precise correspondence as compared to directly computing matching between image frames that are not adjacent to each other. When there is an object moving at a high speed between image frames, matching with respect to the object can be computed more properly than otherwise by performing concatenation.

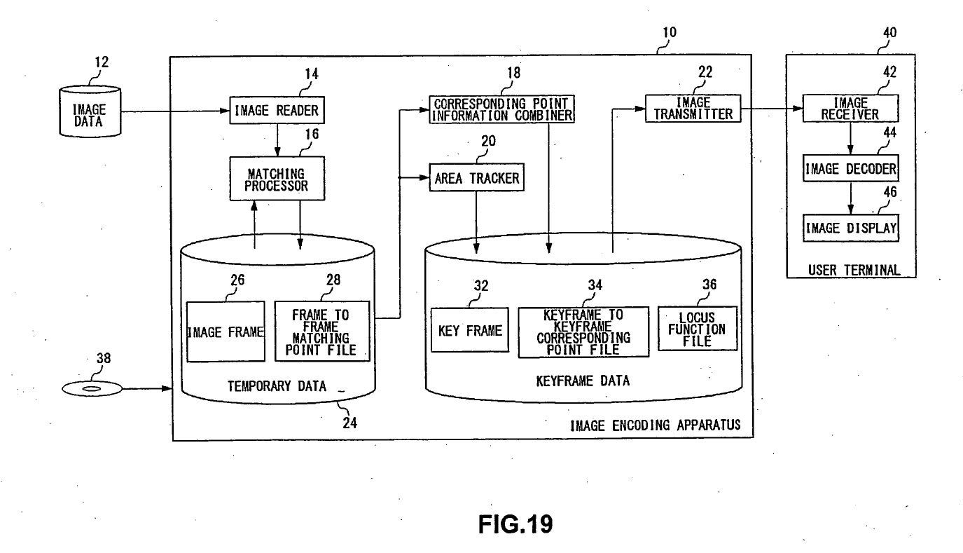

FIG. 19 shows the structure of an image processing system according to the embodiment. In the image processing system, an image encoding apparatus 10 and a user terminal 40 are connected via the Internet (not shown). The image encoding apparatus 10 is provided with an image reader 14, a matching processor 16, a corresponding point information combiner 18, an area tracker 20, an image transmitter 22, a temporary data storage 24 and a keyframe data storage 30. The user terminal 40 is provided with an image receiver 42, an image decoder 44 and an image display 46. The image encoding apparatus 10 has the function as a computer. The blocks may be implemented in hardware by elements such as a CPU or a memory of a computer, and in software by a program having an image processing function. FIG. 19 depicts functional blocks implemented by coordination of hardware and software. The functional blocks may be implemented in a variety of manners by a combination of hardware and software. These functional blocks may be stored as software in a recording medium 38, installed in a hard disk and read into a memory for processing by a CPU.

The image reader 14 of the image encoding apparatus 10 reads consecutive image frames from an image data storage 12 and temporarily stores the frames as image frame data 26 in the temporary data storage 24. The image data storage 12 may be provided in the image encoding apparatus 10 or in a server connected to the apparatus 10 via a communication means. The matching processor 16 acquires the image frame data 26 stored in the temporary data storage 24, determines corresponding points by sequentially computing matching between two adjacent image frames of the entirety of consecutive image frames. The processor 16 stores in the temporary data storage 24 a frame to frame corresponding point information file 28 which describes the correspondence. The matching processor 16 computes matching between image frames by, for example, applying a multiresolutional critical point filter according to the base technology to two adjacent image frames.

The corresponding point information combiner 18 sequentially combines corresponding points in the intermediate frames occurring between a source image frame and a destination image frame, by referring to the frame to frame corresponding point information file 28, where one of the image frames forming the image frame data 26 stored in the temporary data storage 24 is the source and another image frame is the destination. In this way, the combiner 18 determines corresponding points in the source image frame and destination image frame. The source image frame and the destination image frame are referred to as “keyframes”. The corresponding point information combiner 18 stores keyframe data 32 and a keyframe to keyframe corresponding point file 34 which describes the correspondence between the keyframes, in association with each other.

An area tracker 20 tracks backward the corresponding points by using the frame to frame corresponding point file 28, so as to determine a locus occurring as the corresponding points change their relative positions (i.e., move) between image frames. The locus is acquired in the form of parametric function such as NURBS function or Bezier function. The tracker 20 stores a resultant locus function file 36 in the keyframe data storage 30. The image transmitter 22 transmits the keyframe data 32 and the keyframe to keyframe corresponding point file 34 to the user terminal. The image transmitter 22 may transmit the keyframe data 32 and the locus function file 36 to the user terminal 40.

The image receiver 42 receives the keyframe data 32 plus the keyframe to keyframe corresponding point file 34 or the locus function file 36. The image decoder 44 derives the intermediate frames from the keyframe data 32 by using the keyframe to keyframe corresponding point file 34 or the locus function file 36. The image display 46 reproduces consecutive images by using the keyframes and the intermediate frames.

FIG. 20 shows how corresponding points in frames are sequentially combined. A locus of image areas P1, P2, P3, . . . Pn lies between consecutive image frames F1, F2, F3, . . . Fn. The matching processor 16 sequentially computes matching between the image frames F1 and F2, between F2 and F3 . . . . A matching process is a process for obtaining correspondence between image areas in two image frames. For example, the process detects correspondence between areas (e.g., points, specified portions, or lines such as outlines and edges) in the images. For matching, the multiresolutional critical point filter technology and the image matching technology using the filter, disclosed in Japanese patent No. 2927350 to us, may be used. Alternatively, methods using color information, block matching using luminance information and position information, methods extracting outlines or edges and using that information may be used. Still alternatively, a combination of these methods may be used.

The matching processor 16 stores the correspondence, obtained by matching between the image frames F1 and F2, between F2 and F3, . . . and between Fn−1 and Fn, in corresponding point files M1, M2, . . . and Mn−1. The corresponding point information combiner 18 sequentially refers to the corresponding point files M1, M2, . . . Mn−1 so as to obtain the correspondence between the image frames F1 and Fn and store the correspondence thus obtained in a keyframe to keyframe corresponding point file KM. For example, the area P1 in the image frame F1 corresponds to the area P2 in the image frame F2 and to the area P3 in the image frame F3. The correspondence is sequentially combined so that it is determined that the area P1 in the image frame F1 corresponds to the area Pn in the image frame Fn.

The matching processor 16 and the corresponding point information combiner 18 operate to obtain the correspondence between the image frames F1 and Fn that are not adjacent to each other. While computation of matching between the image frames F1 and Fn that are not adjacent to each other may not result in accurate correspondence being obtained due to discontinuity in moving images, sequential combination of correspondence between adjacent image frames results in accurate correspondence being obtained even between jumpy image frames.

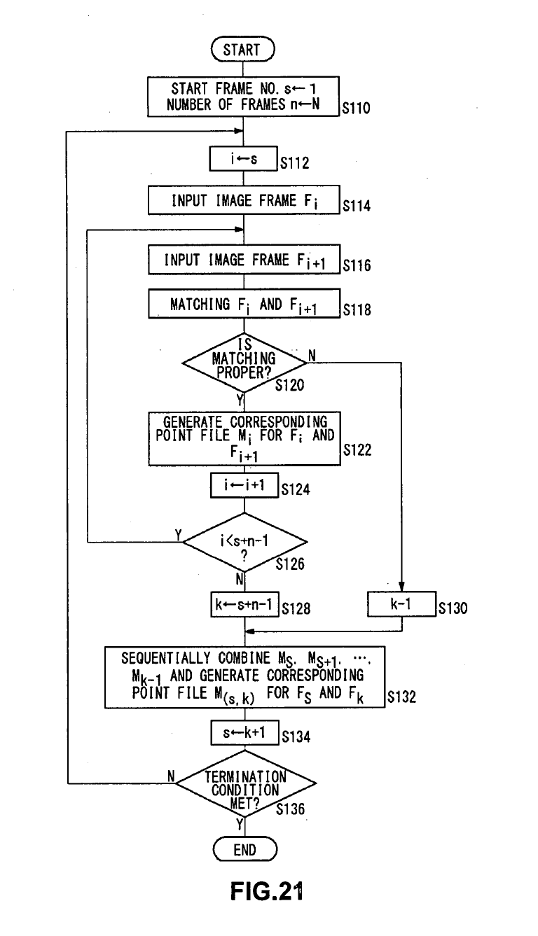

FIG. 21 is a flowchart showing a matching method for generating correspondence between keyframes by sequentially combining correspondence between adjacent frames. A start frame No. s is set to 1 and the number of frames combined n is set to N (S110). The start frame No. s is substituted into a variable i representing the frame number (S112). An image frame Fi is input (S114). An image frame Fi+1 is input (S116). The matching processor 16 computes matching between the image frames Fi and Fi+1 (S118). The matching processor 16 checks whether matching is good (S120). If it is determined matching is good (Y in S120), the processor 16 generates a corresponding point information file Mi for the image frames Fi and Fi+1 and stores the file in the matching processor 16 (S122). The variable i is incremented by 1 (S124) and a determination is made as to whether the variable i is smaller than s+n−1 (S126). When the variable i is smaller than s+n−1 (Y in S126), control is returned to step S116. If not, i.e., when the incremented variable i is equal to s+n−1 (N in S126), the value s+n−1 is substituted into a variable k (S128).

The corresponding point information combiner 18 reads the corresponding point information files Ms, Ms+1, . . . Mk−1 generated by the matching processor 16 from the temporary data storage 24 and sequentially combines the files so as to generate a corresponding point information file M(s, k) between the image frames Fs and Fk (S132). The corresponding point information combiner 18 stores the image frames Fs and Fk as the keyframe data 32, and stores the corresponding point information file M(s, k) as the keyframe to keyframe corresponding point file 34. k+1 is substituted into the start frame No. s (S134). A check is performed to determine whether a condition for termination is met (e.g., whether the start frame No. is equal to or greater than a preset value) (S136). When the condition. is not met (N in S136), control is returned to step S112. When the condition is met (Y in S136), the process is terminated.

When matching is poor in step S120 (N in S120), the variable i is substituted into the variable k (S130), and control is turned to step S132. When matching is poor, it means that the image frames Fs through Fi are continuous, but discontinuity occurs in the image frame Fi+1 as a result of, for example, a scene change. In this case, the image frames Fs and Fi are designated as keyframes so that corresponding point information files for the image frames Fs through Fi are combined. The image frame Fi+1 and subsequent images are subject to a matching process and a combination process, with the image frame Fi+1 being a source.

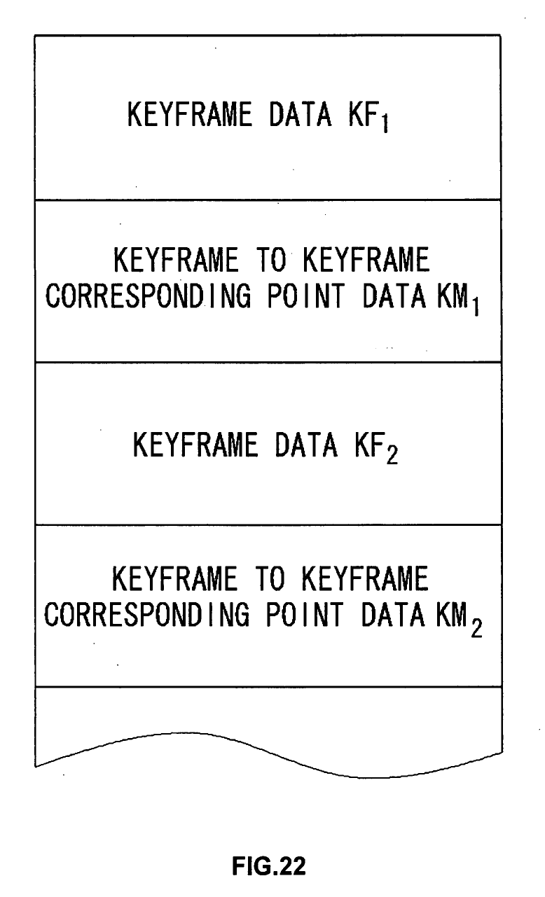

FIG. 22 shows image data in which keyframe data and keyframe to keyframe corresponding point data are associated with each other. Image data is stored in the order of keyframe data and keyframe to keyframe corresponding point data. More specifically, corresponding point data KM1 for the keyframes F1 and F2 is inserted between keyframe data FF1 and keyframe data KF2. The keyframe data storage 30 may store the keyframe data 32 and the keyframe to keyframe corresponding point file 34 in the format as described. Alternatively, the image transmitter 22 may convert the format of image data in this way when transmitting the data to the user terminal 40. The keyframe data is compressed in itself by an image compression method such as JPEG. The keyframe to keyframe corresponding point data may also be compressed by a method for compressing documents.

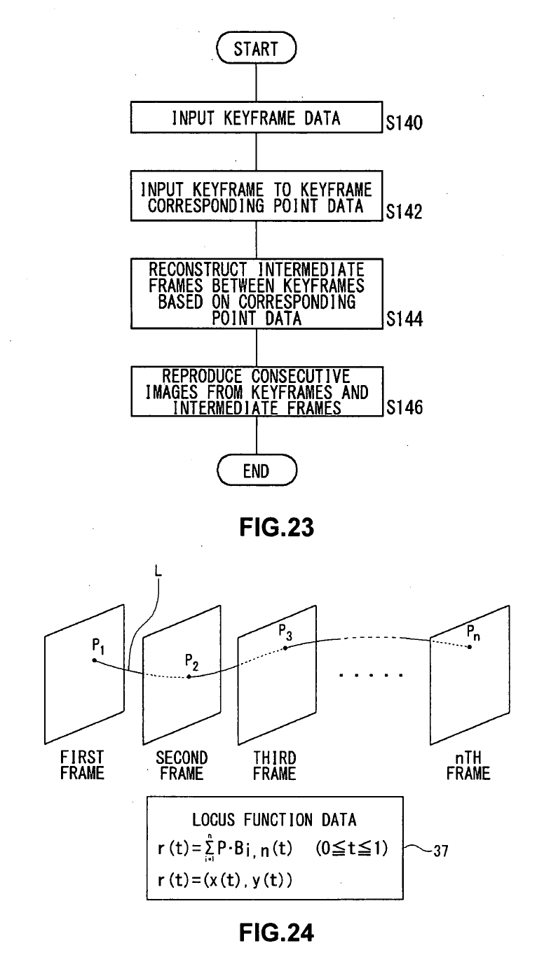

FIG. 23 is a flowchart showing a method of decoding image data. The image receiver 42 of the user terminal 40 receives image data transmitted from the image transmitter 22 of the image encoding apparatus 10 so as to extract keyframe data (S140) and keyframe to keyframe corresponding point data (S142) from the image data. The image decoder 44 reconstructs the intermediate frames between the keyframes by referring to the keyframe to keyframe corresponding point data (S144). The image display 46 reproduces consecutive images by using the keyframes and the intermediate frames for display (S146).

In the above description, it is assumed that the corresponding point information for the intermediate frames is discarded once the correspondence between the keyframes is obtained and that only the keyframe data and the corresponding point information file for the keyframes are transmitted to the user terminal 40. Alternatively, at least a part of the corresponding point information for the intermediate frames may be retained and transmitted to the user terminal 40. This will enhance the reproducibility of the consecutive images. In a yet alternative approach, the locus of corresponding points between the intermediate frames may be represented as a mathematical function so that the function data is supplied to the user terminal 40.

FIG. 24 shows an example of locus function data. The point P1 in the first frame corresponds to the point P2 in the second frame, the point P3 in the third frame, . . . and the point Pn in the nth frame. The function approximating a locus that connects the point P1 and the point Pn, which are corresponding points in the keyframes, and passes through the intermediate points P2 and Pn−1 will be denoted by L. The function L is, for example, a parametric function such as a NURBS function or a Bezier function. The locus tracker 20 refers to the corresponding point information file for image frames so as to obtain locus function data 37 by applying an appropriate parametric function. By representing the locus as a mathematical function and by minimizing the order n of the function, the locus of corresponding points can be represented with a smaller capacity than required for the original corresponding point information file. Since the functional representation of a locus enables representing the position of a corresponding point even where there is no image frame, consecutive images can be reproduced by increasing the number of frames.

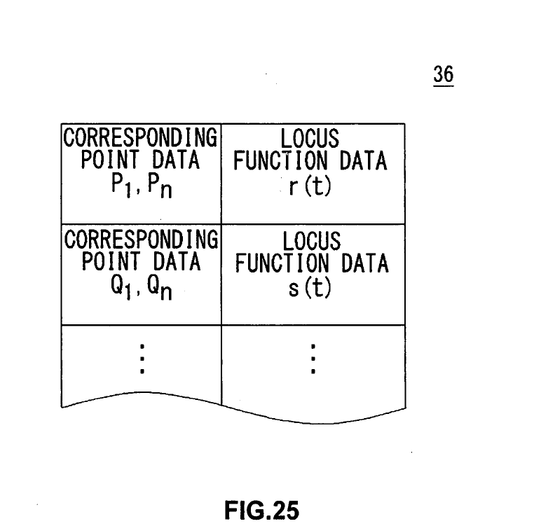

FIG. 25 shows a locus function file 36 that stores corresponding point data for keyframes and the locus function data, in association with each other. The locus function file 36 stores, in association with each other, corresponding point data for the keyframes and locus function data that approximates the locus of the corresponding points that move in the intermediate frames. The user terminal 40 is configured to decode the intermediate frames so as to reproduce the consecutive images, by using the locus function file 36.

As mentioned before, images can be compression coded according to the embodiment by discarding the intermediate frames and storing a keyframe to keyframe corresponding point information file. Since the correspondence between the keyframes is generated by repeatedly computing matching between the intermediate frames, more accurate information is obtained than by directly computing matching between the keyframes. In particular, precision in matching is improved in a case where there is an object that changes its position between the keyframes.

### Embodiment Related to Keyframe to Keyframe Matching under a Constraint Condition

Meanwhile, we have become aware of one aspect related to the adverse effects on image quality from an error occurring when concatenation is used.

Errors occurring as matching is computed between image frames are considered to have a nature of Brownian motion. Thus, according to our conclusion, errors are not canceled and are accumulated as the correspondence between image frames is combined. Especially, the errors accumulated while concatenation is performed for a large number of image frames tend to be larger than the errors occurring when image matching is directly computed between the image frames at the start and end of concatenation.

It was learned that accumulation of errors particularly affects the subjective image quality of an object that moves relatively slowly or remains stationary. For example, the texture or outline of an object will be blurred, shimmering or shaky, giving the viewer that something is wrong with the image. The phenomenon is more acutely felt visually with a slowly moving or stationary object than with a fast moving object. This is because slight blur or shimmering of an object moving fast is hardly noticed by a viewer due to its high speed.

Our study based upon these observations has resulted in an inventive method for improving the subjective image quality of the image as a whole. The method involves improving the precision of matching for a slowly moving or stationary object, while maintaining the advantage of concatenation with regard to a fast moving object. The invention is summarized as a method for improving the subjective image quality of the image as a whole, while maintaining the matching result for an object for which proper image matching is obtained. An embodiment of the invention will now be described.

In this embodiment, an image processing apparatus (e.g., the image encoding apparatus 10) computes matching between two keyframes by using known correspondence between the two keyframes as a constraint condition. Matching between the two keyframes may be carried out by applying a multiresolutional critical point filter according to the base technology to the two keyframes. Other methods may also be used. By using the known correspondence as a constraint condition, precision is improved as compared to a case where matching is merely computed directly between the two keyframes. Hereinafter, one of the two keyframes will be referred to as a first keyframe, and the other will be referred to as a second keyframe.

That the correspondence is “known” means that the correspondence used as a constraint condition is obtained by applying an appropriate image processing algorithm to the first and second keyframes prior to computing matching between the two keyframes. The image processing apparatus may subject the first and second keyframes to an appropriate matching process in order to obtain the correspondence. Generation of correspondence used as a constraint condition and keyframe to keyframe matching under the constraint condition may be performed in parallel, if such an operation presents no harm. Computation of keyframe to keyframe matching for defining a constraint condition may hereinafter be referred to as initial matching or preparatory matching. Keyframe to keyframe matching under the constraint condition may be referred to as updating matching or primary matching.

The image processing apparatus can use various image processing algorithms to define a constraint condition. It is preferable that, of the corresponding point information obtained between the keyframes by the image processing algorithm, the corresponding point information evaluated to be highly reliable be used as a constraint condition. For example, of the corresponding point information obtained between the keyframes by the aforementioned concatenation, a pair of a characteristic point or hint point in the first keyframe and a corresponding point in the second keyframe evaluated to be highly reliable may be defined as a constraint condition.

That the reliability is high means that matching precision is high either objectively or subjectively. When an absolute error in a specific set of corresponding point information is smaller than that of other corresponding point information sets, an evaluation that reliability of the specific set of corresponding point information is high may be made. Alternatively, an evaluation that reliability is high may be made when a relative error in matching is small. For example, an evaluation that reliability of the specific set of corresponding point information is high may be made when the proportion of a matching error with respect to the amount of movement of pixels between target frames for matching is small. For example, an error of five pixels occurring in pixels that move by 100 pixels between image frames differs from an error of one pixel in pixels that move by 10 pixels in that the former error is greater than the latter in absolute error but is smaller than the latter in relative error.

Alternatively, the corresponding point information on a given object may be evaluated to be highly reliable when the subjective image quality of the object is more favorable than that of the other objects. For example, when blur or shimmering of the same degree occurs in a fast moving object and a slowly moving or stationary object, the subject image quality of the fast moving object is more favorable. It can therefore be said that the corresponding point information on the fast moving object is more reliable.

The image processing method according to the embodiment may include preparatory matching and primary matching. Typically, primary matching is performed upon completion of preparatory matching. In preparatory matching, the image encoding apparatus 10 computes matching between the first keyframe and the second keyframe so as to preparatorily generate corresponding point information indicating correspondence between the first and second keyframes. Upon completion of preparatory matching, primary matching updates the keyframe to keyframe corresponding point information by re-computing image matching between the first and second keyframes under the constraint condition established based on the corresponding point information indicating correspondence between the first and second keyframes. Primary matching and preparatory matching may be computed with the same level of resolution.

When the result of computation in preparatory matching is evaluated to be good, it is not essential to perform primary matching. In this case, the result of computation in preparatory matching may be retained as keyframe to keyframe corresponding point information, without performing primary matching.

The algorithm for performing preparatory matching and the algorithm for performing primary matching may include a common image matching algorithm. The common image matching algorithm may be an algorithm for performing image matching by applying a multiresolutional critical point filter to each of the two image frames. Concatenation may be used in preparatory matching. Image matching between keyframes may be directly computed in primary matching.

The image processing method according to the embodiment may include a concatenation step and a refinement step. In the concatenation step, the image encoding apparatus 10 generates keyframe to keyframe corresponding point information by combining corresponding point information obtained by computing matching between two adjacent image frames in a group of image frames which includes a first keyframe and a second keyframe as a source and a destination, respectively. In the refinement step, image matching is directly computed between the first and second keyframes by using, as a constraint condition, a pair comprising a characteristic point in the first keyframe and a point in the second keyframe corresponding to the characteristic point by referring to the keyframe to keyframe corresponding point information. That is, in the refinement step, image matching is directly computed between image frames designated as a source and a destination in the concatenation step under the constraint condition.

In this way, image matching between the keyframes is directly computed by using, as a constraint condition, the highly reliable correspondence obtained as a result of concatenation. Accordingly, the correspondence evaluated to be relatively less reliable due to accumulation of errors inherent in Brownian motion can be updated to correspondence obtained by direct matching between the two keyframes, thereby reducing adverse effects from accumulation of errors.

By using concatenation in initial matching or preparatory matching, matching can be computed with favorable precision for an object that moves fast between the two keyframes, i.e., an object that moves a relatively great distance between the two keyframes. Meanwhile, updating matching or primary matching directly computes matching between the two keyframes. Therefore, matching can be computed properly for a stationary object. Thus, the subject image quality of the image as a whole can be improved by maintaining the favorable matching result obtained for a moving object in the initial matching as a constraint condition, and by updating the result in updating matching for a motionless object.

In this embodiment, using concatenation in initial matching is not essential. For initial matching, the image encoding apparatus 10 may directly compute matching by applying a multiresolutional critical point filter to each of the two image frames. Alternatively, other known matching processes such as block matching may be used. In this case, as in the case in which the base technology is used, the image encoding apparatus 10 preferably uses, of the entirety of keyframe to keyframe corresponding point information obtained by initial matching, the corresponding point information evaluated to be highly reliable as a constraint condition.

The image encoding apparatus 10 according to the embodiment may use an image processing algorithm for detecting a characteristic point in the first keyframe. The image processing algorithm for detecting a characteristic point is for detecting a characteristic point in an image of the first keyframe. For example, the algorithm may be a known algorithm for performing an edge detection method or an optical flow method. The edge detection method is for extracting a boundary of an object in an image. The optical flow method is for deriving a locus of points with the highest luminance, for each area in an image. The image processing algorithm for detecting a characteristic point may be for detecting a point in a moving object identified by concatenation and for establishing the point as a characteristic point.

The image processing algorithm for detecting a characteristic point may define a characteristic point by using different methods at a time. For example, a point on a fast moving object obtained by concatenation may be defined as a characteristic point, and an edge of the fast moving object may be detected by the edge detection method and defined as a characteristic point. In this way, image matching for a fast moving object may be properly maintained as a constraint condition in primary matching.

Alternatively, a characteristic point detected by the edge detection method and a characteristic point detected by the optical flow method may both be defined as characteristic points.

Points derived that empirically produce highly reliable correspondence between keyframes is preferably defined as characteristic points in preference to other points. In this respect, it is particularly favorable that the image processing algorithm for detecting a characteristic point define an edge of a fast moving object as a characteristic point. Points inside a fast moving object, i.e., points other than the edges, may be defined as characteristic points. An edge of a slowly moving or stationary object may be defined as a characteristic point. The choice of a characteristic point that yields an optimal result depends on the moving images processed. Therefore, adjustment may be made on an empirical or experimental basis.

A pair of a characteristic point in the first keyframe and a point in the second keyframe corresponding to the characteristic point is defined as a constraint condition. The point in the second keyframe corresponding to the characteristic point in the first keyframe may be identified by, for example, referring to the keyframe to keyframe corresponding point information obtained by initial matching. Alternatively, a pair of a characteristic point and a corresponding point may be user defined. The characteristic point and the corresponding point may not be limited to a “point” in the geometrical sense but may encompass graphics other than “points”. For example, one-dimensional graphics such as lines or two-dimensional graphics such as polygons are encompassed. That is, the term “corresponding point in the second keyframe” refers to an arbitrary area in the second keyframe associated with the characteristic point in the first keyframe and may be a point in the image, a set of points, a continuous or discontinuous specified portion, an outline, an edge line, etc.

The concatenation step may include an adjacent matching step and a combination step. In the adjacent matching step, the image encoding apparatus 10 computes matching between two adjacent image frames in an image frame group which includes the first keyframe and the second keyframe as a source and a destination, respectively, thereby generating corresponding point information for the pairs of adjacent image frames. The image encoding apparatus 10 may generate corresponding point information for each pair of image frames by applying a multiresolutional critical point filter to each of the two adjacent image frames. In the combination step, the image encoding apparatus 10 generates the corresponding point information indicating the correspondence between the first and second keyframes by combining the corresponding point information generated for the pairs of the adjacent image frames.

The refinement step may include a characteristic point detection step, a constraint condition defining step and a keyframe to keyframe matching step. In the characteristic point detection step, the image encoding apparatus 10 detects a characteristic point in the image of the first keyframe. The image encoding apparatus 10 may detect, as a characteristic point in the first keyframe, a point included in an object determined to move between the first and second keyframes by referring to the keyframe to keyframe corresponding point information. The image encoding apparatus 10 may define an edge detected by the edge detection method as a characteristic point in the first keyframe. The image encoding apparatus 10 may define a high-luminance point detected by the optical flow method as a characteristic point in the first keyframe. The image encoding apparatus 10 may detect a characteristic point in an area other than the periphery of the image of the first keyframe.

In the constraint condition defining step, the image encoding apparatus 10 acquires a point in the second keyframe corresponding to the characteristic point in the first keyframe thus detected, by referring to the keyframe to keyframe corresponding point information, so as to define the pair of the characteristic point and the corresponding point as a constraint condition. In the keyframe to keyframe matching step, the image encoding apparatus 10 computes image matching between the first and second keyframes by applying a multiresolutional critical point filter to each of the two image frame under the constraint condition.

The image encoding apparatus 10 may inspect whether the result of computation in the refinement step gives favorable image matching. For this purpose, the image encoding apparatus 10 determines, with reference to a preset standard for inspection, whether the computation result in the refinement step approximates the keyframe to keyframe corresponding point information generated in the concatenation step. When it is determined that the result approximates the information, the image encoding apparatus 10 uses the result of computation as the corresponding point information indicating correspondence between the first and second keyframes. Since the keyframe to keyframe corresponding point information obtained as a result of concatenation is considered to be generally precise, there is a possibility that the matching result is improper if the corresponding point information generated in the refinement step is significantly different from the information obtained as a result of concatenation. By introducing the step of inspection, reduction in precision due to the execution of keyframe to keyframe direct matching under the constraint condition is avoided.

The image processing method according to the embodiment may process a total of n image frames including the first image frame through the nth image frame. In this method, correspondence occurring in the first image frame and the nth image frame is identified by tracking a fast moving object from the first image frame to the nth image frame. For a slowly moving object, correspondence is directly identified between the first image frame and the nth image frame. By identifying correspondence using different methods depending on the moving speed of an object, matching precision in the image as a whole is improved.

The image encoding apparatus 10 identifies correspondence between the first image frame and the nth image frame with respect to a fast moving object, by subjecting n image frames including the first image frame through the nth image frame to concatenation. The image encoding apparatus 10 identifies correspondence between the first image frame and the nth image frame with respect to a slowly moving object of a stationary object by, for example, directly computing matching between the first image frame and the nth image frame. In directly computing matching between the first image frame and the nth image frame, the image encoding apparatus 10 may utilize the correspondence, already obtained, between the first image frame and the nth image frame with respect to a fast moving object. In this way, it is ensured that the subjective image quality of the image as a whole is favorable.

The image encoding apparatus 10 differentiates between a fast moving object and a slowly moving object in a single image frame. For example, the image encoding apparatus 10 determines that an object is a fast moving object if the amount of motion of the object is greater than a predetermined threshold value. Conversely, when the amount of motion of the object is smaller than the predetermined threshold value, the object is determined as a slowly moving object or a stationary object. The threshold value may be defined on an empirical basis so that favorable correspondence is obtained. The amount of motion of an object may be defined as an average of the amount of movement of pixels included in an object between two image frames. The two image frames may be two adjacent image frames or a first image and an nth image frame.

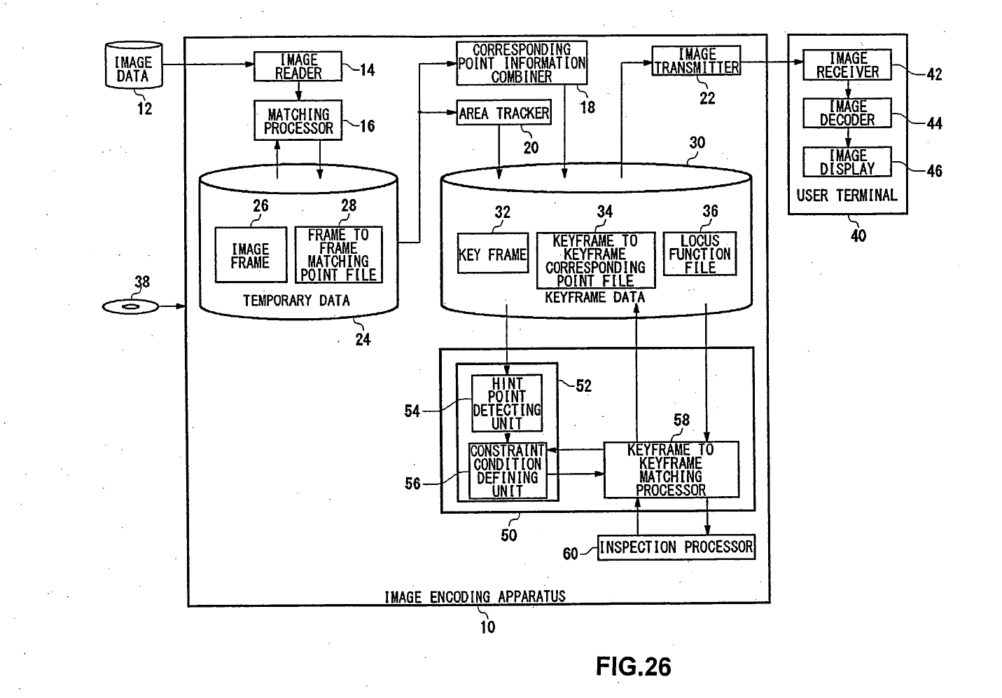

FIG. 26 shows an example of the image processing system according to the embodiment. The image encoding apparatus shown in FIG. 26 is basically of the same structure as the image encoding apparatus 10 shown in FIG. 19, the difference being that a refinement process unit 50 and an inspection processor 60 are added. In this embodiment, the concatenation process unit is so configured as to include the matching processor 16 and the corresponding point information combiner 18. Hereinafter, the description of those aspects of the apparatus of FIG. 26 that are similar to the corresponding aspects of the image encoding apparatus 10 shown in FIG. 19 will be omitted. The description below only highlights the differences.

The refinement process unit 50 performs the refinement step. More specifically, the refinement process unit 50 directly computes matching between the first keyframe and the second keyframe by using, as a constraint condition, a pair comprising a characteristic point or hint point in the first keyframe and a point in the second keyframe identified as being corresponding to the hint point-by referring to the keyframe to keyframe corresponding point information. The refinement process unit 50 includes a constraint condition defining unit 52 and a keyframe matching processor 58.

The constraint condition defining unit 52 includes a hint point detecting unit 54 and a constraint condition defining unit 56. The hint point detecting unit 54 reads the keyframe data 32, detects a hint point in the image of the first keyframe, and outputs the hint point thus detected to the constraint condition defining unit 56. The constraint condition defining unit 56 obtains a point in the second keyframe corresponding to the hint point in the first keyframe supplied from the hint point detecting unit 54 so as to define a pair comprising the hint point and the corresponding point as a constraint condition. The constraint condition defining unit 56 outputs the constraint condition to the keyframe to keyframe matching processor 58. The keyframe to keyframe corresponding point file 34 may be corresponding point information obtained by concatenation.

The constraint condition defining unit 56 may identify a corresponding point by using an initial matching result obtained by the keyframe to keyframe matching processor 58 by directly computing matching between the first and second keyframes without being bounded by the constraint condition. In this process, the keyframe to keyframe matching processor 58 may compute matching between keyframes by applying a multiresolutional critical point filter to the first and second keyframes.

The keyframe to keyframe matching processor 58 reads the first and second keyframes from the keyframe data storage 30 and computes image matching between the first and second keyframes under the constraint condition supplied from the constraint condition defining unit 56. The keyframe to keyframe matching processor 58 outputs the result of matching between the first and second keyframes to the inspection processor 60. The keyframe to keyframe matching processor 58 stores the result of matching between the first and second keyframes in the keyframe data storage 30, reflecting the result of inspection in the inspection processor 60 in the data thus stored.

The inspection processor 60 determines whether the result of computing matching between the first and second keyframes output from the refinement process unit 50 approximates the keyframe to keyframe corresponding point information generated as a result of concatenation. The inspection processor 60 determines that the result of matching computation is proper when the result output from the refinement process unit 50 meets a preset standard for inspection. Conversely, when the result of computation output from the refinement process unit 50 does not meet the preset standard for inspection, the inspection processor 60 determines that the result of computation is improper. The standard for inspection is preset so that the image encoding apparatus 10 determines whether a difference between the result of computation obtained and the standard for inspection falls within a predetermined range. The standard for inspection may be appropriately defined by experiments, simulation or the like.

The inspection processor 60 outputs a result of determination to the refinement process unit 50 or, more specifically, to the keyframe to keyframe matching processor 58. When the result of inspection by the inspection processor 60 is favorable, the keyframe to keyframe matching processor 58 stores the corresponding point information obtained by the refinement process unit 50 in the keyframe data storage 30 as the updated keyframe to keyframe corresponding point file 34. When the result of inspection by the inspection processor 60 is improper, the keyframe to keyframe matching processor 58 discards the result of matching by the refinement process unit 50 and maintains the original keyframe to keyframe matching point file 34 in the keyframe data storage 30.

In this embodiment, the preparatory processor is so configured as to include the matching processor 16 and the corresponding point information combiner 18. The primary matching processor is so configured as to include the refinement process unit 50.

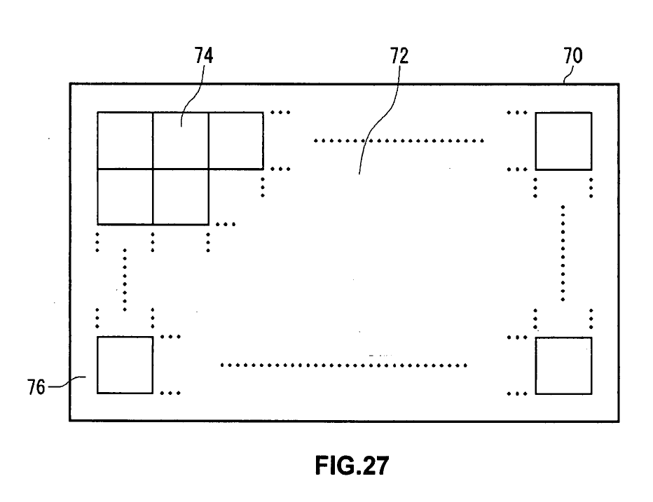

FIG. 27 shows how a hint point is detected according to the embodiment. FIG. 27 shows a single keyframe 70. The hint point detecting unit 54 partitions the keyframe 70 read from the keyframe data storage 30 into a central portion 72 and a peripheral portion 76. The central portion occupies the majority of the image and is defined so as not to include the periphery of the image. The central portion 72 is defined so as not to include at least the outermost pixels of the image. The hint point detecting unit 54 partitions the central portion 72 of the keyframe 70 into a plurality of blocks 74. Each block includes a plurality of pixels and is of, for example, a rectangular shape. The hint point detecting unit 54 partitions the central portion 72 into matrix form so as to define the blocks 74. The hint point detecting unit 54 detects at least one hint point in each of the blocks 74. When a hint point is not detected in a block 74, the hint point detecting unit 54 does not have to define a hint point in the block 74. The hint point detecting unit 54 does not define a hint point in the peripheral part 76 of the keyframe 70. This is because, when a hint point is defined in the image periphery of the first keyframe, there is a possibility that the second keyframe does not have a corresponding point due to the movement of an object. In other words, there is a possibility that the object that includes the hint point is not in the second keyframe.

The hint point detecting unit 54 may extract the amount of movement of pixels from the keyframe to keyframe corresponding point file 34 obtained as a result of concatenation and define a point with the amount of motion equal to or greater than a predetermined threshold value as a hint point. Alternatively, a point with the maximum amount of motion in a each block 74 may be defined as a hint point. The hint point detecting unit 54 may convert the keyframe to keyframe corresponding point file 34 obtained by concatenation into a displacement map. A displacement map is of a format for image data which is a grayscale representation of the amount of movement of pixels between keyframes. The hint point detecting unit 54 may define an edge detected by the edge detection method as a hint point in the keyframe 70. The hint point detecting unit 54 may define a high-luminance point detected by the optical flow method as a hint point in the first keyframe 70. The hint point detecting unit 54 may maintain a grayscale representation of the result of applying the edge detection method or the optical flow method to the keyframe 70 in a format for image data.

The hint point detecting unit 54 refers to the image data in a grayscale representation and generates a hint point candidate list listing pixels with a grayscale value exceeding a predetermined threshold value as candidates for hint points. When only a single point from a given block 74 is included in the hint point candidate list, the point is defined as a hint point in that block 74. When there is no point in the hint point candidate list, no hint point is defined in the block 74. For a block 74 where there are a plurality of points included in the hint point candidate list, the plurality of points may be defined as hint points. Alternatively, a certain standard for narrowing candidates may be applied so as to define surviving points as hint points. For example, a point having the maximum pixel value, of the plurality of candidates, may be defined as a hint point.

The hint point detecting unit 54 may adjust the positions of hint points so that a plurality of hint points are not too close to each other. That is, the hint point detecting unit 54 may adjust the positions of hint points so that any two hint points are spaced apart by a predetermined distance or more. For this purpose, the hint point detecting unit 54 may, for example, determine whether a distance between hint points exceeds a predetermined threshold value. When a distance between hint points is below the threshold value, another hint point is selected from the hint point candidate list so as to determine on the distance between the hint points again. The aforementioned steps are repeated until the distance between hint points exceeds the threshold value. When hint points cannot be defined such that a distance between hint points exceeds the threshold value, hint points may not be provided in the associated block. Alternatively, determination may be repeated using a smaller threshold value. The threshold value may be determined on, for example, an experimental basis.

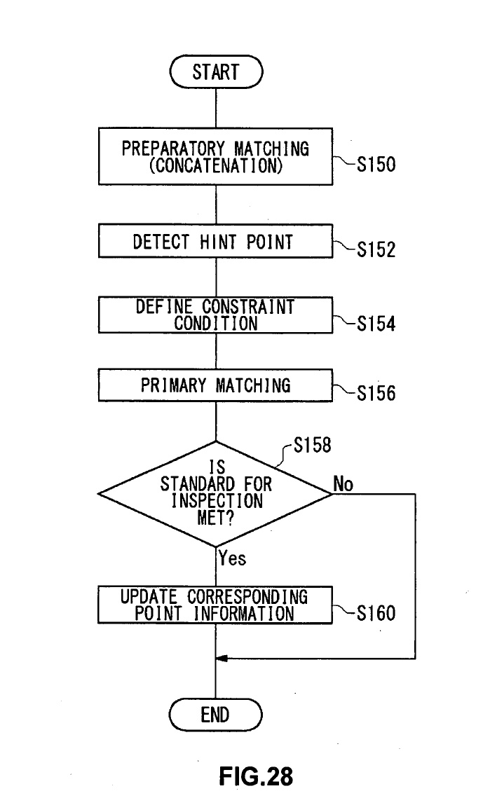

FIG. 28 is a flowchart showing how keyframe to keyframe matching is computed under a constraint condition according to this embodiment. Initially, the image encoding apparatus 10 performs preparatory matching between keyframes (S150). In this embodiment, preparatory matching is performed by using concatenation. The image encoding apparatus 10 generates a frame to frame corresponding point file for the pairs of adjacent image frames by applying a multiresolutional critical point filter to each of the two image frames in a group of consecutive image frames. The image encoding apparatus 10 generates a keyframe to keyframe corresponding point file by combining the frame to frame corresponding point files generated for the adjacent pairs of image frames.

Subsequently, the image encoding apparatus detects a hint point in a keyframe (S152). The image encoding apparatus 10 establishes a pair, comprising a hint point in one of the adjacent keyframes and a point in the other keyframe corresponding to the hint point, as a constraint condition (S154).

The image encoding apparatus 10 further performs primary matching (S156). That is, the image encoding apparatus 10 generates a keyframe to keyframe corresponding point file for the pairs of adjacent keyframes by applying a multiresolutional critical point filter to each of the adjacent keyframes under the constraint condition thus established (S156).

The image encoding apparatus 10 determines whether the keyframe to keyframe corresponding point file obtained by primary matching matches the standard for inspection (S158). When a difference between the result of preparatory matching and the result of primary matching is determined to fall within a predetermined range (Yes in S158), the image encoding apparatus 10 updates the keyframe to keyframe corresponding point file with the file obtained by primary matching, before terminating the process (S160). If it is determined that the difference between the result of preparatory matching and the result of primary matching does not fall within a predetermined range (No in S158), the image encoding apparatus 10 does not use the result of primary matching and maintains the keyframe to keyframe corresponding point file obtained by preparatory matching.

An exemplary operation of the present invention with the above-mentioned structure will be described below. Moving image data is prepared first. For example, a movie showing scenery captured by moving a camera slowly will be assumed. The movie captures birds flying around at a relatively high speed in the neighborhood of a camera person and far-off mountains. The movie data includes objects that move relatively slowly. The far-off mountains appear to move slowly due to the movement of the camera. The birds flying around are relatively fast moving objects.

For example, concatenation is performed on the original movie data for preparatory matching. As a result, basically favorable image matching is established by computation between keyframes so that compressed image data is obtained accordingly. Favorable subjective image quality is achieved with regard to the images of fast moving objects such as birds. Meanwhile, the subject image quality of the outlines of mountains that move slowly suffers due to blur or shimmering, as compared to the fast moving objects.

Subsequently, hint points in keyframes are extracted. For example, the outlines of mountains may be defined as hint points by the edge detection method. Points delineating flying birds that are characterized by a large amount of displacement as identified by concatenation are defined as hint points. Edges are also detected and defined as hint points.

Pairs comprising these hint points and the corresponding points in the corresponding keyframe are established as a constraint condition. Correspondence between the hint points and the corresponding points is obtained by computation in preparatory matching. Thus, correspondence identified as a result of computation in preparatory matching and evaluated to be highly reliable is defined as a constraint condition.

Primary matching is computed under the constraint condition thus established. In primary matching, image matching may be directly computed between keyframes. In this way, there is reasonable expectancy that more favorable result of computation will be obtained than with preparatory matching. However, the computation result might not be so favorable as expected depending on the target of processing. Accordingly, inspection is performed on the result of computation in primary matching. Since there is reasonable expectancy that preparatory matching produces a basically favorable computation result, it is ensured that the computation result of primary matching is not used when the result of computation in primary matching and the result of computation in preparatory matching are largely incompatible. When the standard for inspection is met, the result of computation in primary matching is accepted.

In this approach, image matching between the keyframes is directly computed by using, of the entire keyframe to keyframe corresponding point information obtained by preparatory matching, highly reliable correspondence information as a constraint condition. In this way, matching precision is improved. For example, when concatenation is used in preparatory matching, adverse effects, from accumulation of errors occurring as a result of concatenation, on image quality is mitigated. In particular, experiments have shown that the subjective image quality of a slowly moving object or a stationary object is improved.

What is claimed is:

1. An image processing method comprising:
concatenating, whereby keyframe to keyframe corresponding point information is generated by combining corresponding point information indicating correspondence between image frames obtained by subjecting an image frame group which includes a first keyframe and a second keyframe as a source and a destination, respectively, to a matching process; and
refining, whereby direct image matching is computed between the first keyframe and the second keyframe by using, of the entire keyframe to keyframe corresponding point information, the corresponding point information evaluated to be highly reliable as a constraint condition.

2. The image processing method according to claim 1, wherein
the refining comprises: characteristic point detecting, whereby a characteristic point in an image of the first keyframe is detected;
constraint condition defining, whereby a point in the second keyframe corresponding to the characteristic point in the first keyframe thus detected is obtained from the keyframe to keyframe corresponding point information, and a pair comprising the characteristic point and the corresponding point is defined as a constraint condition; and
keyframe to keyframe matching, whereby image matching is directly computed between the first keyframe and the second keyframe under the constraint condition.

3. The image processing method according to claim 2, wherein
in the characteristic point detecting, a point included in an object determined to move between the first and second keyframes by referring to the keyframe to keyframe corresponding point information is detected as a characteristic point in the first keyframe.

4. The image processing method according to claim 2, wherein
in the characteristic point detecting, a characteristic point is detected in an area other than the periphery of the image of the first keyframe.

5. The image processing method according to claim 2, wherein
in the keyframe to keyframe matching, corresponding point information indicating correspondence between the first and second keyframes is obtained by applying a multiresolutional critical point filter to the first and second keyframes under the constraint condition.

6. The image processing method according to claim 1, further comprising:
inspecting, whereby, when it is determined, with reference to a preset standard for inspection, that the result of computation in the refining approximates the keyframe to keyframe corresponding point information generated in the concatenating, the corresponding point information indicating correspondence between the first and second keyframes is updated according to the result of computation.

7. An image processing method comprising:
preparatory matching, whereby corresponding point information indicating correspondence between a first keyframe and a second keyframe is preparatorily generated by computing image matching between the first and second keyframes; and
primary matching, whereby, subsequently the corresponding point information indicating correspondence between the keyframes is updated by re-computing image matching between the first and second keyframes under a constraint condition defined based on the corresponding point information indicating correspondence between the first and second keyframes.

8. The image processing method according to claim 7, wherein
an algorithm for performing preparatory matching and an algorithm for performing primary matching includes a common image matching algorithm.

9. An image processing method comprising: preparatory matching, whereby corresponding point information indicating correspondence between a first keyframe and a second keyframe is preparatorily generated by computing image matching between the first and second keyframes; and primary matching, whereby image matching between the first and second keyframes is computed with the same level of resolution as used in preparatory matching, under a constraint defined based on corresponding point information indicating correspondence between the first and second keyframes.

10. The image processing method according to claim 9, wherein
an algorithm for performing preparatory matching and an algorithm for performing primary matching includes a common image matching algorithm.

11. An image processing apparatus comprising:
a concatenation processor operative to generate keyframe to keyframe corresponding point information by combining corresponding point information obtained by computing matching between adjacent two image frames in a group of image frames which includes a first keyframe and a second keyframe as a source and a destination, respectively; and
a refinement processor operative to directly compute image matching between the first and second keyframes by using, of the entire keyframe to keyframe corresponding point information, the corresponding point information evaluated to be highly reliable as a constraint condition.

12. The image processing apparatus according to claim 11, wherein the refinement processor comprises:
a characteristic point detecting unit operative to detect a characteristic point in an image of the first keyframe;
a constraint condition defining unit operative to obtain a point in the second keyframe corresponding to the characteristic point in the first keyframe thus detected from the keyframe to keyframe corresponding point information, and define a pair comprising the characteristic point and the corresponding point as a constraint condition; and
a keyframe to keyframe matching processor operative to directly compute matching between the first keyframe and the second keyframe matching under the constraint condition.

13. The image processing apparatus according to claim 12, wherein
the characteristic point detecting unit detects a point included in an object determined to move between the first and second keyframes by referring to the keyframe to keyframe corresponding point information as a characteristic point in the first keyframe.

14. The image processing apparatus according to claim 12, wherein
the characteristic point detecting unit detects a characteristic point in an area other than the periphery of the image of the first keyframe.

15. The image processing apparatus according to claim 11, further comprising:
an inspection processor operative to use, when it is determined, with reference to a preset standard for inspection, that the result of computation in the refining approximates the keyframe to keyframe corresponding point information generated in the concatenating, the result of computation as the corresponding point information indicating correspondence between the first and second keyframes.

16. An image processing apparatus comprising:
a preparatory matching processor operative to preparatorily generate corresponding point information indicating correspondence between a first keyframe and a second keyframe by computing image matching between the first and second keyframes;
a primary matching processor operative to subsequently update the corresponding point information indicating correspondence between the keyframes by re-computing image matching between the first and second keyframes under a constraint condition defined based on the corresponding point information indicating correspondence between the first and second keyframes.

17. An image processing apparatus comprising:
a preparatory matching processor operative to preparatorily generate corresponding point information indicating correspondence between a first keyframe and a second keyframe by computing image matching between the first and second keyframes;
a primary matching processor operative to compute image matching between the first and second keyframes with the same level of resolution as used in preparatory matching, under a constraint defined based on corresponding point information indicating correspondence between the first and second keyframes.

18. An image processing method which processes n image frames including a first through nth image frames, the method comprising:
identifying correspondence between the first image frame and the nth image frame by tracking a fast moving object from the first image frame to the nth image frame; and
directly identifying correspondence between the first image frame and the nth image frame with respect to a slowly moving object.
